(19) United States
(12) Patent Application Publication
(10) Pub. No.: US 2013/0029225 A1
(43) Pub. Date: Jan. 31, 2013

(54) ACTIVE MATERIAL, METHOD OF MANUFACTURING THE SAME, ELECTRODE, SECONDARY BATTERY, BATTERY PACK, ELECTRIC VEHICLE, ELECTRIC POWER STORAGE SYSTEM, ELECTRIC POWER TOOL, AND ELECTRONIC DEVICE

(71) Applicants: Takaaki Matsui, Fukushima (JP); Tadashi Matsushita, Fukushima (JP); Takehiko Ishii, Fukushima (JP)

(72) Inventors: Takaaki Matsui, Fukushima (JP); Tadashi Matsushita, Fukushima (JP); Takehiko Ishii, Fukushima (JP)

(73) Assignee: SONY CORPORATION, Tokyo (JP)

(21) Appl. No.: 13/558,005

(22) Filed: Jul. 25, 2012

(30) Foreign Application Priority Data
Jul. 28, 2011 (JP) 2011-165514

(51) Int. Cl. H01M 4/1391; B29C 67/04; H01M 4/131

(52) U.S. Cl. 429/220; 429/221; 429/223; 429/224; 429/229; 429/231.1; 429/231.3; 429/231.5; 429/231.6; 429/231.95; 264/678

(57) ABSTRACT

A secondary battery includes: a cathode including an active material; an anode; and an electrolytic solution. The active material has a composition represented by Formula (1) described below. A median diameter (D90) of the active material is from about 10.5 micrometers to about 60 micrometers both inclusive, the median diameter (D90) being measured by a laser diffraction method. A half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

### CROSS REFERENCES TO RELATED APPLICATIONS

The present application claims priority to Japanese Priority Patent Application JP 2011-165514 filed in the Japan Patent Office on Jul. 28, 2011, the entire content of which is hereby incorporated by reference.

### BACKGROUND

The present application relates to an active material which is Li phosphate having an olivine crystal structure, a method of manufacturing the same, an electrode using the active material, a secondary battery using the active material, a battery pack using the secondary battery, an electric vehicle using the secondary battery, an electric power storage system using the secondary battery, an electric power tool using the secondary battery, and an electronic device using the secondary battery.

In recent years, electronic devices represented by a mobile phone, a personal digital assistant (PDA), and the like have been widely used, and it has been strongly demanded to further reduce their size and weight and to achieve their long life. Accordingly, as an electric power source for the electronic devices, a battery, in particular, a small and light-weight secondary battery capable of providing a high energy density has been developed. In recent years, it has been considered to apply such a secondary battery not only to the foregoing electronic devices but also to various applications represented by a battery pack attachably and detachably loaded on the electronic devices or the like, an electric vehicle such as an electric automobile, an electric power storage system such as a home electric power server, or an electric power tool such as an electric drill.

As the secondary battery, secondary batteries using various charge and discharge principles have been widely proposed. Specially, a secondary battery using lithium ions as an electrode reactant and the like are considered promising, since such a secondary battery and the like provide a higher energy density than lead batteries, nickel cadmium batteries, and the like.

The secondary battery includes a cathode, an anode, and an electrolytic solution. The cathode contains a cathode active material that inserts and extracts an electrode reactant. In order to obtain a high battery capacity, as a cathode active material, an Li composite oxide containing Li and a transition metal as constituent elements is widely used. Examples of the Li composite oxide include LiCoO₂ or LiNiO₂ having a bedded salt crystal structure (space group: R3m) and LiMn₂O₄ having a spinel crystal structure (space group: Fd3m).

Specially, as the bedded salt Li composite oxide, LiNiO₂ is more prospective than LiCoO₂. This is because, a discharge capacity of LiNiO₂ (about from 180 mAh/g to 200 mAh/g both inclusive) is higher than a discharge capacity of LiCoO₂ (about 150 mAh/g). Further, it is because, Ni is more inexpensive than Co, and has superior supply stability.

In the case where LiNiO₂ is used, a high theoretical capacity and a high discharge electric potential are obtained. On the other hand, in the case where charge and discharge are repeated, the crystal structure of LiNiO₂ easily collapses, and therefore battery performance (discharge capacity or the like) and safety (heat stability or the like) are possibly lowered.

Therefore, it is proposed that Li phosphate having an olivine crystal structure (space group: Pnma) and containing Li and a transition metal as constituent elements be used to resolve the foregoing disadvantage with regard to battery performance and safety. This is because, since crystal structural change thereof at the time of charge and discharge is little, superior cycle characteristics are obtained. Further, this is because, O and P are stably covalently-bonded in the crystal structure thereof, oxygen release is suppressed even in a high temperature environment, and therefore superior stability is also obtained.

Specifically, Fe-based Li phosphate (LiFePO₄) containing Fe as a constituent element that abundantly exists as a resource and is inexpensive is used (for example, see Japanese Unexamined Patent Application Publication No. 09-134724). In this case, it is proposed that secondary particles (aggregate of primary particles) be compressed down to a predetermined bulk density after firing in a first stage, and subsequently firing in a second stage be performed to increase an amount capable of being fired at once and improve manufacturing efficiency (for example, see Japanese Unexamined Patent Application Publication No. 2008-257894).

Fe-based Li phosphate has the foregoing advantage. Meanwhile, Fe-based Li phosphate has a disadvantage that its energy density is low. Therefore, Mn-based Li phosphate (LiMnₓFe_{y}PO₄ (x+y=1)) further containing Mn as a constituent element is used. In a charge and discharge curve of Mn-based Li phosphate, a plateau region corresponding to Mn exists in the vicinity of 4 V, and therefore high energy density is obtained. In this case, it is proposed that a carbon material be added before a firing step to perform compression in order to securely perform single-phase synthesis of a complex and the carbon material (for example, see Japanese Unexamined Patent Application Publication No. 2002-117848). In some cases, Mn-based Li phosphate further contains other transition metal or the like as a constituent element.

### SUMMARY

In terms of securing superior battery performance, Mn-based Li phosphate is a major candidate as a cathode active material. However, Mn-based Li phosphate has a large disadvantage in which electron conductivity thereof is lower than that of Fe-based Li phosphate by about 1×10⁻³. Further, solid solubility of Mn and Fe tends to be low. Therefore, ability of Mn-based Li phosphate is not perfectly used yet substantially. Accordingly, in high load conditions, a sufficient discharge capacity has not been obtained yet.

It is desirable to provide an active material capable of obtaining a high discharge capacity even in high load conditions, a method of manufacturing the same, an electrode, a secondary battery, a battery pack, an electric vehicle, an electric power storage system, an electric power tool, and an electronic device.

According to an embodiment of the present application, there is provided an active material including: a cathode including an active material; an anode; and an electrolytic solution. The active material has a composition represented by Formula (1) described below. A median diameter (D90) of the active material is from about 10.5 micrometers to about 60 micrometers both inclusive, the median diameter (D90) being measured by a laser diffraction method. A half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

According to an embodiment of the present application, there is provided an electrode including an active material, the active material having a composition represented by Formula (1) described below. A median diameter (D90) of the active material is from about 10.5 micrometers to about 60 micrometers both inclusive, the median diameter (D90) being measured by a laser diffraction method. A half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

According to an embodiment of the present application, there is provided a secondary battery including: a cathode including an active material; an anode; and an electrolytic solution. The active material has a composition represented by Formula (1) described below. A median diameter (D90) of the active material is from about 10.5 micrometers to about 60 micrometers both inclusive, the median diameter (D90) being measured by a laser diffraction method. A half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

According to an embodiment of the present application, there is provided a battery pack including: a secondary battery, the second battery including a cathode including an active material, an anode, and an electrolytic solution; a control section controlling a usage state of the secondary battery; and a switch section switching the usage state of the secondary battery according to a direction of the control section. The active material has a composition represented by Formula (1) described below. A median diameter (D90) of the active material is from about 10.5 micrometers to about 60 micrometers both inclusive, the median diameter (D90) being measured by a laser diffraction method. A half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

According to an embodiment of the present application, there is provided an electric vehicle including: a secondary battery, the second battery including a cathode including an active material, an anode, and an electrolytic solution; a conversion section converting electric power supplied from the secondary battery to drive power; a drive section driving the electric vehicle according to the drive power; and a control section controlling a usage state of the secondary battery. The active material has a composition represented by Formula (1) described below. A median diameter (D90) of the active material is from about 10.5 micrometers to about 60 micrometers both inclusive, the median diameter (D90) being measured by a laser diffraction method. A half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

According to an embodiment of the present application, there is provided an electric power storage system including: a secondary battery, the second battery including a cathode including an active material, an anode, and an electrolytic solution; one, or two or more electric devices; and a control section controlling electric power supply from the secondary battery to the one, or two or more electric devices. The active material has a composition represented by Formula (1) described below. A median diameter (D90) of the active material is from about 10.5 micrometers to about 60 micrometers both inclusive, the median diameter (D90) being measured by a laser diffraction method. A half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

According to an embodiment of the present application, there is provided an electric power tool including: a secondary battery, the second battery including a cathode including an active material, an anode, and an electrolytic solution; and a movable section being supplied with electric power from the secondary battery. The active material has a composition represented by Formula (1) described below. A median diameter (D90) of the active material is from about 10.5 micrometers to about 60 micrometers both inclusive, the median diameter (D90) being measured by a laser diffraction method. A half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

According to an embodiment of the present application, there is provided an electronic device including: a secondary battery, the second battery including a cathode including an active material, an anode, and an electrolytic solution. The electronic device is supplied with electric power from the secondary battery. The active material has a composition represented by Formula (1) described below. A median diameter (D90) of the active material is from about 10.5 micrometers to about 60 micrometers both inclusive, the median diameter (D90) being measured by a laser diffraction method. A half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

According to an embodiment of the present application, there is provided a method of manufacturing an active material, the method including: compressing a powdery raw material to form a molded product; and subsequently firing and pulverizing the molded product to form an active material having a composition represented by Formula (1) described below. Density of the molded product in the compressing of the powdery raw material is from about 0.5 milligrams per cubic centimeter to about 2.3 milligrams per cubic centimeter both inclusive. A median diameter (D50) of the active material in the pulverizing of the molded product is from about 5 micrometers to about 30 micrometers both inclusive.

LiₐMn_{b}Fe_{c}M_{d}PO₄ (1)

where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

The median diameters (D90 and D50) are measured by using a laser diffraction particle size distribution meter LA-920 available from Horiba., Ltd. The half bandwidth is measured by using X-ray diffraction instrument RINT2000 available from Rigaku Corporation. Measurement conditions of the half bandwidth are as follows. That is, CuKα ray is used as a lamp bulb, measurement range (2θ) is from 10 deg to 90 deg both inclusive, step is 0.02 deg, and counting time is 1.2. Further, the density of the molded product is calculated by density (mg/cm³)=weight of the molded product (mg)/volume of the molded product (cm³).

According to the active material, the electrode, and the secondary battery according to the embodiments of the present application, the median diameter (D90) of the active material including the composition represented by Formula (1) is from 10.5 μm to 60 μm both inclusive, and the half bandwidth (2θ) of the diffraction peak corresponding to the (020) crystal plane is from 0.15 deg to 0.24 deg both inclusive. Therefore, a high discharge capacity is obtainable even in high load conditions. Further, in the battery pack, the electric vehicle, the electric power storage system, the electric power tool, and the electronic device according to the embodiments of the present invention each using the foregoing secondary battery, similar effects are obtainable.

According to the method of manufacturing an active material according to the embodiment of the present application, the molded product obtained by compressing the powdery raw material is fired and subsequently pulverized. The density of the molded product in the compressing of the powdery raw material is from 0.5 mg/cm³ to 2.3 mg/cm³ both inclusive, and the median diameter (D50) of the active material in the pulverizing of the molded product is from 5 μm to 30 μm both inclusive. Therefore, an active material having the foregoing configuration (median diameter (D90)) and physical properties (half bandwidth) is obtainable.

It is to be understood that both the foregoing general description and the following detailed description are exemplary, and are intended to provide further explanation of the application as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the application.

FIG. 1 is a cross-sectional view illustrating a configuration of a secondary battery (cylindrical type) according to an embodiment of the present application.

FIG. 2 is a cross-sectional view illustrating an enlarged part of a spirally wound electrode body illustrated in FIG. 1.

FIG. 3 is a perspective view illustrating a configuration of a secondary battery (laminated film type) according to an embodiment of the present application.

FIG. 4 is a cross-sectional view taken along a line IV-IV of a spirally wound electrode body illustrated in FIG. 3.

FIG. 5 is a block diagram illustrating a configuration of an application example (battery pack) of the secondary battery.

FIG. 6 is a block diagram illustrating a configuration of an application example (electric vehicle) of the secondary battery.

FIG. 7 is a block diagram illustrating a configuration of an application example (electric power storage system) of the secondary battery.

FIG. 8 is a block diagram illustrating a configuration of an application example (electric power tool) of the secondary battery.

FIG. 9 is a cross-sectional view illustrating a configuration of a secondary battery (coin type) for a test.

### DETAILED DESCRIPTION

An embodiment of the present application will be hereinafter described in detail with reference to the drawings. The description will be given in the following order.

### 1. Active Material

1-1. Configuration

1-2. Method of Manufacturing Active Material

1-3. Function and Effect

### 2. Application Examples of Active Material

2-1. Electrode and Secondary Battery (Cylindrical Type)

2-2. Electrode and Secondary Battery (Laminated Film Type)

### 3. Applications of Secondary Battery

3-1. Battery Pack

3-2. Electric Vehicle

3-3. Electric Power Storage System

3-4. Electric Power Tool

[1. Active Material/1-1. Configuration]

First, a description will be given of a configuration of an active material according to an embodiment of the present application.

The active material is used for, for example, an electrode of a secondary battery or the like, and has a composition represented by the following Formula (1). That is, the active material herein explained is Mn-based Li phosphate having an olivine crystal structure (space group: Pnma). Such Mn-based Li phosphate is preferable, since crystal structure change thereof at the time of electrode reaction is little, and oxygen release is suppressed even in a high temperature environment. Further, by using such Mn-based Li phosphate, high energy density is also obtained.

LiₐMn_{b}Fe_{c}M_{d}PO₄ (1)

In the formula, M represents one or more of Mg, Ni, Co, Al, W, Nb, Ti, Si, Cr, Cu, and Zn. 0<a≦2, 0<b<1, 0<c<1, 0≦d<1, and b+c+d=1 are established.

As seen in the foregoing ranges of possible values of b, c, and d, the active material typically contains Mn and Fe as constituent elements together with Li. Meanwhile, the active material may contain M, or does not necessarily contain M. a to d may be arbitrary numerical values as long as the numerical values are within the foregoing ranges.

Specially, the active material preferably has a composition represented by the following Formula (2). This is because, a higher effect is thereby obtained. However, the active material may have other composition as long as the conditions shown in Formula (1) are satisfied.

LiMn_{b1}Fe_{c1}PO₄ (2)

In the formula, 0<b1<1, 0<c1<1, and b1+c1=1 are established.

The active material is capable of inserting and extracting an electrode reactant. As seen in the after-mentioned method of manufacturing the active material, the active material is an aggregate (secondary particles) of primary particles obtained at the time of manufacture.

A median diameter (D90) of the active material measured by a laser diffraction method is from 10.5 μm to 60 μm both inclusive. A half bandwidth (2θ) of a diffraction peak corresponding to a (020) crystal plane of the active material measured by an X-ray diffraction method is from 0.15 deg to 0.24 deg both inclusive. The median diameter (D90) herein described is, as described above, a particle diameter of the secondary particle.

The median diameter (D90) is within the foregoing range for the following reason. That is, in this case, a particle distribution becomes appropriate in terms of the relationship with crystalline characteristics of the active material, and therefore the electrode reactant is easily inserted or extracted even at the time of electrode reaction in high load conditions. More specifically, in the case where the median diameter is smaller than 10.5 μm, the half bandwidth is largely decreased. Thereby, crystalline characteristics of the primary particles are excessively lowered, or a surface of the primary particles becomes amorphous, and accordingly the electrode reactant is less likely to be inserted or extracted. Meanwhile, in the case where the median diameter is larger than 60 μm, the half bandwidth is largely increased. Thereby, crystal growth of the primary particles excessively proceeds, a diffusion distance of the electrode reactant becomes large, and therefore output characteristics are largely lowered. Further, since the active material with a large particle diameter exists, short-circuit may occur resulting from the active material bursting through a separator at the time of fabricating a secondary battery or the like.

The half bandwidth is within the foregoing range for the following reason. That is, in this case, crystalline characteristics of the active material becomes appropriate, and therefore the electrode reactant is more easily inserted or extracted even at the time of charge and discharge in high load conditions. More specifically, in the case where the half bandwidth is smaller than 0.15 deg, crystal growth of the primary particles excessively proceeds, and therefore a diffusion distance of the electrode reactant becomes large. Meanwhile, in the case where the half bandwidth is larger than 0.24 deg, crystalline characteristics of the primary particles are excessively lowered, or the surface of the primary particles becomes amorphous, and accordingly the electrode reactant is less likely to be inserted or extracted.

The median diameter (D90) is controlled, for example, according to pulverization conditions (pulverization intensity, pulverization time, and the like) in a manufacturing step of the active material described later. Further, the half bandwidth is controlled according to firing conditions (firing temperature, firing time, and the like) in a manufacturing step of the active material.

The median diameter (D90) is measured by using laser diffraction particle size distribution meter LA-920 available from Horiba., Ltd. The half bandwidth is measured by using X-ray diffraction instrument RINT2000 available from Rigaku Corporation. Measurement conditions of the half bandwidth are as follows. That is, CuKα ray is used as a lamp bulb, measurement range (2θ) is from 10 deg to 90 deg both inclusive, step is 0.02 deg, and counting time is 1.2. For defining the half bandwidth, attention is paid to the (020) crystal plane for the following reason. That is, the (020) crystal plane is a plane on which the electrode reactant (in this case, Li) is diffused.

[1-2. Method of Manufacturing Active Material]

Next, a description will be given of a method of manufacturing the foregoing active material.

In manufacturing the active material, first, a powdery raw material (primary particle) necessary for forming the active material having the composition represented by the foregoing Formula (1) is prepared. The raw material is one, or two or more materials to become a supply source of respective elements (Li, Mn, Fe, M, P, and O).

The material to become a supply source of Li is not particularly limited. Examples thereof include one, or two or more of inorganic acid salts, organic acid salts, organic metal-containing compounds, and the like. Examples of the inorganic acid salts include lithium chloride, lithium bromide, lithium carbonate, lithium nitrate, lithium phosphate, and lithium hydroxide. Examples of the organic acid salts include lithium acetate and lithium oxalate. Examples of the organic metal-containing compounds include lithium alkoxide such as lithium ethoxide.

The material to become a supply source of Mn is not particularly limited. Examples thereof include one, or two or more of manganese chloride (II), manganese acetate (II), manganese phosphate (II), trihydrate, and the like.

The material to become a supply source of Fe is not particularly limited. Examples thereof include one, or two or more of iron oxalate (II)•dihydrate, iron phosphate (II)•octahydrate, iron chloride (II) hydrate, ferrous sulfate (III)•heptahydrate, iron acetate (II)•tetrahydrate, iron phosphate hydrate, and the like.

The material to become a supply source of M is not particularly limited. In the case where M is Al, examples thereof include one, or two or more of Al salts such as aluminum hydroxide and aluminum alkoxide.

The material to become a supply source of P and O is not particularly limited. Examples thereof include one, or two or more of phosphoric acid, ammonium hydrogenphosphate salt, and the like. Examples of phosphoric acid include orthophosphoric acid and metaphosphoric acid. Examples of ammonium hydrogenphosphate salt include hydrogenphosphate diammonium ((NH₄)₂HPO₄) and dihydrogenphosphate ammonium (NH₄H₂PO₄).

It is to be noted that a material (a compound, an alloy, or the like) already containing arbitrary two or more of the foregoing respective elements as constituent elements may be used.

Subsequently, the powdery raw materials are mixed, and subsequently the resultant mixture is compressed to form a molded product. In this case, for example, the mixture is dispersed in a solvent to obtain a solution or a suspension, and the solution or the like is subsequently sprayed by using a spray drying method or the like. Thereby, the raw material powder (primary particles) is aggregated (becomes secondary particles), and therefore a powdery active material precursor is obtained. By compressing the powdery active material precursor, a molded product is obtained. After that, the molded product is heated at temperature, for example, equal to or less than 400 deg C., and preferably equal to or less than 200 deg C.

In the compression step, a density of the molded product is set to a value from 0.5 mg/cm³ to 2.3 mg/cm³ both inclusive, and, for example, a tablet molding machine is used. The density of the molded product is calculated by density (mg/cm³)=weight of the molded product (mg)/volume of the molded product (cm³).

The density is within the foregoing range for the following reason. That is, in this case, solid solubility of Mn and Fe becomes high, and therefore resistance is lowered and crystalline characteristics of the active material become appropriate. More specifically, in the case where the density is less than 0.5 mg/cm³, the half bandwidth of the diffraction peak corresponding to the (020) crystal plane is out of the range from 0.15 deg to 0.24 deg both inclusive. Meanwhile, in the case where the density is larger than 2.3 mg/cm³, necking occurs among the first particles, and therefore a particle diameter thereof is increased. Thereby, a diffusion distance of the electrode reactant is increased, and therefore resistance is increased as well.

It is to be noted that though a thickness of the molded product is not particularly limited, specially, the thickness thereof is preferably equal to or less than 6 mm. Thereby, firing unevenness is less likely to occur in a firing step described later, and therefore solid solubility of Mn and Fe becomes higher.

Though a shape of the molded product is not particularly limited, for example, the shape of the molded product is preferably discoid (tablet-like or pellet-like). This is because, in this case, the shape of the molded product is easily controlled, and the thickness thereof is easily controlled to be uniform as a whole. However, the shape of the molded product may be other shape.

Though the solvent used for dispersion is not particularly limited, for example, the solvent used for dispersion is one, or two or more of pure water, a mixed solvent of the pure water and an organic solvent, and the like. The organic solvent is, for example, alcohol, ketone, ether, or the like. Specially, in terms of easy handling and safety, the pure water is preferable.

In the case where the raw materials are mixed, as needed, an electron conductive material or a precursor thereof (electron conductive material precursor) may be added thereto. This is because, the raw material (primary particles) becomes the secondary particles with the electron conductive material or the like, and therefore electric resistance of the active material precursor (secondary particles) is lowered.

Examples of the electron conductive material include one, or two or more of C, Au, Pt, Ag, Ti, V, Sn, Nb, Zr, Mo, Pd, Ru, Rh, Ir, oxides thereof, and the like. Specially, in terms of chemical stability, manufacturing cost, and the like, C as a nonmetal is preferable. Examples of C include carbon black, acetylene black, and graphite. Specially, carbon black or acetylene black is preferable. Further, in terms of similar factors, out of the metals, a noble metal such as Au, Pt, Ag, Pd, Ru, Rh, and Ir is preferable, and Ag is specially preferable.

The electron conductive material precursor is a material to become an electron conductive material by being heated. Examples thereof include one, or two or more of an organic compound, a metal salt, a metal alkoxide, a metal complex, and the like. Though, the organic compound is not particularly limited as long as the organic compound is not evaporated by being heated. Examples thereof include a polymer compound, sugars, and a soluble organic surfactant. Examples of the polymer compound include polyethylene glycol, polypropylene glycol, polyethylene imine, polyvinyl alcohol, polyacrylic ethyl, polyacrylic methyl, polyvinyl butyral, and polyvinyl pyrrolidone. Examples of the sugars include sugar alcohol, sugar ester, and cellulose. Examples of the soluble organic surfactant include polyglycerin, polyglycerinester, sorbitan ester, and polyoxyethylene sorbitan. Alternately, the electron conductive material precursor may be ester phosphate, an ester phosphate salt, or the like.

In the case where an organic compound is contained in the foregoing solution or the like as an electron conductive material precursor since C is used as an electron conductive material, the organic compound is preferably soluble in the solution or the like. This is because, since the electron conductive material precursor is dispersed in the solution or the like on the molecular level, the electron conductive material is easily distributed in the secondary particles uniformly.

In the spray step by using a spray drying method or the like, by spraying the solution or the like in a high temperature environment, the solvent is instantly evaporated, and the primary particles are aggregated to become the secondary particles. In this case, in the case where the electron conductive material is contained in the solution or the like, the primary particles with surfaces covered with the electron conductive material are aggregated.

Subsequently, the molded product of the active material precursor is fired under an inactive atmosphere. Examples of such inactive gas include N₂, Ar, and H₂. Alternately, other gas may be used. Further, firing temperature is from 400 deg C. to 800 deg C. both inclusive, and is preferably from 500 deg C. to 700 deg C. both inclusive. This is because, crystal growth in the molded product easily proceeds, and therefore appropriate crystalline characteristics of the active material are easily obtained.

Finally, the molded product of the active material precursor is pulverized to gain the active material (primary particles) having the composition represented by Formula (1). In this case, for example, one, or two or more pulverizers such as a ball mill, a vibration mill, and a bantam mill are used. Alternately, other type of pulverizer may be used.

In the pulverization step, the median diameter (D50) of the active material after being pulverized (primary particles) is from 5 μm to 30 μm both inclusive. This is because the median diameter (D90) of the active material (secondary particles) falls within the foregoing range (from 10.5 μm to 60 μm both inclusive), and crystalline characteristics of the active material become appropriate. More specifically, in the case where the median diameter is smaller than 5 μm, the active material becomes amorphous. Meanwhile, in the case where the median diameter is larger than 30 μm, the median diameter of the active material (secondary particles) is increased. Therefore, in either case, appropriate crystalline characteristics of the active material are not obtainable.

[1-3. Function and Effect]

According to the active material, the active material has the composition represented by Formula (1), the median diameter (D90) is from 10.5 μm to 60 μm both inclusive, and the half bandwidth of the diffraction peak corresponding to the (020) crystal plane is from 0.15 deg to 0.24 deg both inclusive. Thereby, as described above, crystalline characteristics of the active material become appropriate. Therefore, even at the time of electrode reaction in high load conditions, the electrode reactant is allowed to be smoothly inserted and extracted.

Further, according to the method of manufacturing the active material, after the molded product obtained by compressing the powdery raw material is fired, the resultant is pulverized. In addition, the density of the molded product in the compression step is from 0.5 mg/cm³ to 2.3 mg/cm³ both inclusive, and the median diameter (D50) of the active material in the pulverization step is from 5 μm to 30 μm both inclusive. Therefore, the active material having the foregoing median diameter (D90) and the foregoing half bandwidth is allowed to be obtained. In this case, in the case where the thickness of the molded product in the compression step is equal to or less than 6 mm, and firing temperature in the firing step is from 400 deg C. to 800 deg C. both inclusive, a higher effect is allowed to be obtained.

[2. Application Examples of Active Material]

Next, a description will be given of application examples of the foregoing active material. The active material is used for, for example, an electrode (cathode) of a secondary battery.

[2-1. Electrode and Secondary Battery (Cylindrical Type)]

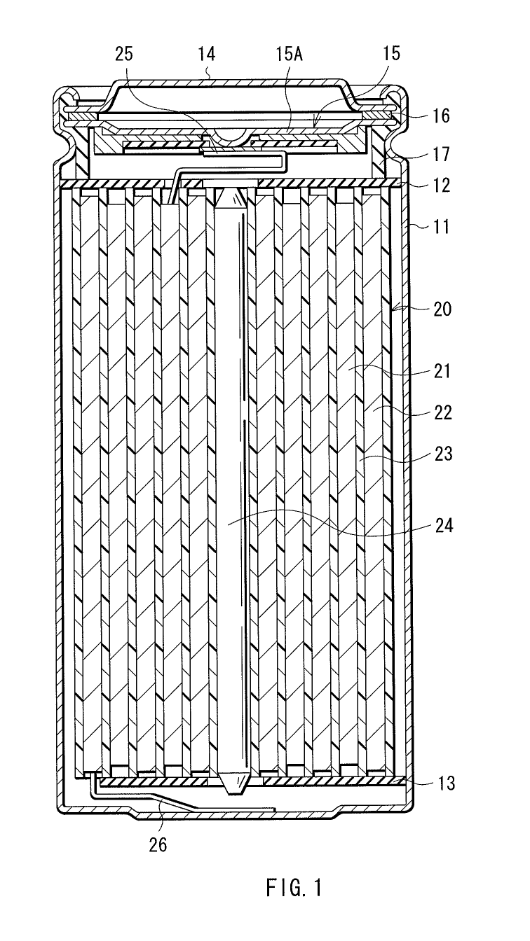

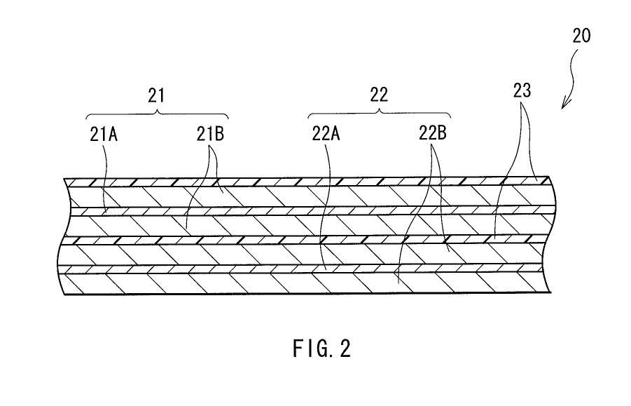

FIG. 1 and FIG. 2 illustrate cross-sectional configurations of a cylindrical type secondary battery. FIG. 2 illustrates enlarged part of a spirally wound electrode body 20 illustrated in FIG. 1. The secondary battery herein described is, for example, a lithium ion secondary battery in which a battery capacity is obtained by insertion and extraction of lithium ions as an electrode reactant (hereinafter simply referred to as “secondary battery” as well).

[Whole Configuration of Secondary Battery]

The secondary battery mainly contains the spirally wound electrode body 20 and a pair of insulating plates 12 and 13 inside a battery can 11 in the shape of a substantially hollow cylinder. The spirally wound electrode body 20 is a spirally wound laminated body in which a cathode 21 and an anode 22 are layered with a separator 23 in between and are spirally wound.

The battery can 11 has a hollow structure in which one end of the battery can 11 is closed and the other end of the battery can 11 is opened. The battery can 11 is made of, for example, Fe, Al, an alloy thereof, or the like. In the case where the battery can 11 is made of Fe, the surface of the battery can 11 may be plated with Ni or the like. The pair of insulating plates 12 and 13 is arranged to sandwich the spirally wound electrode body 20 in between, and to extend perpendicularly to the spirally wound periphery surface.

At the open end of the battery can 11, a battery cover 14, a safety valve mechanism 15, and a positive temperature coefficient device (PTC device) 16 are attached by being swaged with a gasket 17. Thereby, the battery can 11 is hermetically sealed. The battery cover 14 is made of, for example, a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating, or the like, a disk plate 15A inverts to cut the electric connection between the battery cover 14 and the spirally wound electrode body 20. The PTC device 16 prevents abnormal heat generation due to a large current by increasing resistance according to temperature rise. The gasket 17 is made of, for example, an insulating material. The surface thereof may be coated with asphalt.

In the center of the spirally wound electrode body 20, a center pin 24 may be inserted. A cathode lead 25 made of a conductive material such as Al is connected to the cathode 21. An anode lead 26 made of a conductive material such as Ni is connected to the anode 22. The cathode lead 25 is, for example, welded to the safety valve mechanism 15, and is electrically connected to the battery cover 14. The anode lead 26 is, for example, welded to the battery can 11, and is electrically connected to the battery can 11.

[Cathode]

The cathode 21 has, for example, a cathode active material layer 21B on a single surface or both surfaces of a cathode current collector 21A. The cathode current collector 21A is made of, for example, a conductive material such as Al, Ni, and stainless steel. The cathode active material layer 21B contains the foregoing active material (Mn-based Li phosphate) as a cathode active material capable of inserting and extracting lithium ions. As needed, the cathode active material layer 21B may contain other material such as a cathode binder and a cathode electric conductor together with the cathode active material.

The median diameter (D90) and the half bandwidth of the cathode active material contained in the cathode active material layer 21B are checked, for example, by the following procedure. First, the cathode active material layer 21B is exfoliated from the cathode current collector 21A. Subsequently, the cathode active material layer 21B is dissolved in an organic solvent such as N-methyl-2-pyrrolidone (NMP). After that, the resultant is filtered to separate the cathode active material from the cathode binder or the like. Finally, as described above, the median diameter of the cathode active material is measured by using a laser diffraction particle size distribution meter, and the half bandwidth of the cathode active material is measured by using an X-ray diffraction instrument.

The cathode active material layer 21B contains a plurality of fine pores inside thereof. The fine pores are gaps created among each cathode active material. Otherwise, in the case where the cathode active material layer 21B contains the cathode binder or the like together with the cathode active material, the fine pores are gaps created thereamong. The maximum peak pore diameter indicated by percentage change of a mercury penetration amount with respect to the cathode active material layer 21B measured by a mercury injection method is preferably from 0.023 μm to 0.06 μm both inclusive. This is because, in this case, lowering of the discharge capacity is suppressed even in high load conditions.

The foregoing “mercury penetration amount measured by a mercury injection method” is a mercury penetration amount with respect to the cathode active material layer 21B (plurality of fine pores), and is measured by using a mercury porosimeter. More specifically, the mercury penetration amount is a value measured in approximation conditions in which mercury surface tension is 485 mN/m, a mercury contact angle is 130 deg, and relation between a fine pore diameter and a pressure is 180/pressure=pore diameter. In the mercury porosimeter, while pressure P is increased in a stepwise fashion, mercury penetration amount V with respect to a plurality of fine pores is measured. Therefore, percentage change (ΔV/ΔP) of the mercury penetration amount is plotted with respect to a pore diameter. Further, “the maximum peak pore diameter is from 0.023 μm to 0.06 μm both inclusive” means a pore diameter in the maximum peak position is within the range from 0.023 μm to 0.06 μm both inclusive in measurement results of the mercury porosimeter (horizontal axis: pore diameter, vertical axis: percentage change of the mercury penetration amount). The total number of peaks may be one, or two or more.

The cathode active material layer 21B may contain one, or two or more of other cathode active materials together with the cathode active material (Mn-based Li phosphate). Such other cathode active materials are not particularly limited. Examples thereof include LiCoO₂ or LiNiO₂ having a bedded salt crystal structure and LiMn₂O₄ having a spinel crystal structure. Alternately, such other cathode active material may be, for example, an oxide, a disulfide, a chalcogenide, a conductive polymer, or the like. Examples of the oxide include titanium oxide, vanadium oxide, and manganese dioxide. Examples of the disulfide include titanium disulfide and molybdenum sulfide. Examples of the chalcogenide include niobium selenide. Examples of the conductive polymer include sulfur, polyaniline, and polythiophene.

Examples of the cathode binder include one, or two or more of synthetic rubbers, polymer materials, and the like. Examples of the synthetic rubber include styrene butadiene-based rubber, fluorine-based rubber, and ethylene propylene diene. Examples of the polymer material include polyvinylidene fluoride and polyimide.

Examples of the cathode electric conductor include one, or two or more of carbon materials and the like. Examples of the carbon materials include graphite, carbon black, acetylene black, and Ketjen black. The cathode electric conductor may be a metal material, a conductive polymer, or the like as long as the material has electric conductivity.

[Anode]

The anode 22 has, for example, an anode active material layer 22B on a single surface or both surfaces of an anode current collector 22A.

The anode current collector 22A is made of, for example, a conductive material such as Cu, Ni, and stainless steel. The surface of the anode current collector 22A is preferably roughened. Thereby, due to what we call an anchor effect, adhesion characteristics of the anode active material layer 22B with respect to the anode current collector 22A are improved. In this case, it is enough that the surface of the anode current collector 22A in the region opposed to the anode active material layer 22B is roughened at minimum. Examples of roughening methods include a method of forming fine particles by electrolytic treatment. The electrolytic treatment is a method of providing concavity and convexity by forming fine particles on the surface of the anode current collector 22A by an electrolytic method in an electrolytic bath. A copper foil formed by the electrolytic method is generally called “electrolytic copper foil.”

The anode active material layer 22B contains one, or two or more of anode active materials capable of inserting and extracting lithium ions, and may also contain other material such as an anode binder and an anode electric conductor as needed. Details of the anode binder and the anode electric conductor are, for example, respectively similar to those of the cathode binder and the cathode electric conductor. In the anode active material layer 22B, for example, in order to prevent unintentional precipitation of Li metal at the time of charge and discharge, a chargeable capacity of the anode material is preferably larger than a discharge capacity of the cathode 21.

The anode active material is, for example, a carbon material. In the carbon material, crystal structure change at the time of insertion and extraction of lithium ions is extremely small. Therefore, the carbon material provides a high energy density and superior cycle characteristics. Further, the carbon material functions as an anode electric conductor as well. Examples of the carbon material include graphitizable carbon, non-graphitizable carbon in which the spacing of (002) plane is equal to or greater than 0.37 nm, and graphite in which the spacing of (002) plane is equal to or smaller than 0.34 nm. More specifically, examples of the carbon material include pyrolytic carbons, cokes, glassy carbon fiber, an organic polymer compound fired body, activated carbon, and carbon blacks. Of the foregoing, examples of the cokes include pitch coke, needle coke, and petroleum coke. The organic polymer compound fired body is obtained by firing (carbonizing) a polymer compound such as a phenol resin and a furan resin at appropriate temperature. In addition, the carbon material may be a low crystalline carbon or amorphous carbon heat-treated at temperature equal to or lower than about 1000 deg C. The shape of the carbon material may be any of a fibrous shape, a spherical shape, a granular shape, and a scale-like shape.

Further, the anode active material may be, for example, a material (metal-based material) containing one, or two or more of metal elements and metalloid elements as constituent elements, since a high energy density is thereby obtained. Such a metal-based material may be a simple substance, an alloy, or a compound of the metal elements or the metalloid elements, may be two or more thereof, or may have one, or two or more of phases thereof in part or all thereof “Alloy” includes a material containing one or more metal elements and one or more metalloid elements, in addition to a material formed of two or more metal elements. Further, the alloy may contain a nonmetallic element. Examples of the structure thereof include a solid solution, a eutectic crystal (eutectic mixture), an intermetallic compound, and a structure in which two or more thereof coexist.

The foregoing metal element or the foregoing metalloid element is, for example, a metal element or a metalloid element capable of forming an alloy with Li. For example, the foregoing metal element or the foregoing metalloid element is one, or two or more of Mg, B, Al, Ga, In, Si, Ge, Sn, Pb, Bi, Cd, Ag, Zn, Hf, Zr, Y, Pd, and Pt. Specially, Si or Sn or both are preferably used. Si and Sn have a high ability of inserting and extracting lithium ions, and therefore provide a high energy density.

A material containing Si or Sn or both may be, for example, a simple substance, an alloy, or a compound of Si or Sn; two or more thereof; or a material having one, or two or more of phases thereof in part or all thereof. The simple substance only means a general simple substance (a small amount of impurity may be therein contained), and does not necessarily mean a purity 100% simple substance.

Examples of the alloys of Si include a material containing one, or two or more of Sn, Ni, Cu, Fe, Co, Mn, Zn, In, Ag, Ti, Ge, Bi, Sb, Cr, and the like as constituent elements other than Si. Examples of the compounds of Si include a material containing one, or two or more of C, O, and the like as constituent elements other than Si. It is to be noted that, for example, the compounds of Si may contain one, or two or more of the elements described for the alloys of Si as a constituent element other than Si.

Examples of the alloys or the compounds of Si include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO. v in SiOᵥ may be in the range of 0.2<v<1.4.

Examples of the alloys of Sn include a material containing one, or two or more of Si, Ni, Cu, Fe, Co, Mn, Zn, In, Ag, Ti, Ge, Bi, Sb, Cr, and the like as constituent elements other than Sn. Examples of the compounds of Sn include a material containing one, or two or more of C, O, and the like. The compounds of Sn may contain one, or two or more of the elements described for the alloys of Sn as constituent elements other than Sn. Examples of the alloys or the compounds of Sn include SnO, (0<w≦2), SnSiO₃, LiSnO, and Mg₂Sn.

Further, as a material containing Sn, for example, a material containing a second constituent element and a third constituent element in addition to Sn as a first constituent element is preferable. The second constituent element may be, for example, one, or two or more of the following elements. That is, the second constituent element may be one, or two or more of Co, Fe, Mg, Ti, V, Cr, Mn, Ni, Cu, Zn, Ga, Zr, Nb, Mo, Ag, In, Ce, Hf, Ta, W, Bi, and Si. The third constituent element may be, for example, one, or two or more of B, C, Al, and P. This is because, in the case where the second constituent element and the third constituent element are contained, a high battery capacity, superior cycle characteristics, and the like are obtained.

Specially, a material containing Sn, Co, and C (SnCoC-containing material) is preferable. The SnCoC-containing material is a material containing at least Sn, Co, and C as constituent elements, and may contain other element as needed as described later. The composition of the SnCoC-containing material is, for example, as follows. That is, the C content is from 9.9 wt % to 29.7 wt % both inclusive, and the ratio of Sn and Co contents (Co/(Sn+Co)) is from 20 wt % to 70 wt % both inclusive, since high energy density is obtained in such a composition range.

It is preferable that the SnCoC-containing material have a phase containing Sn, Co, and C. Such a phase preferably has a low crystalline structure or an amorphous structure. The phase is a reaction phase capable of reacting with Li. Due to existence of the reaction phase, superior characteristics are obtained. The half bandwidth of the diffraction peak obtained by X-ray diffraction of the phase is preferably equal to or greater than 1 deg based on diffraction angle of 2θ in the case where CuKα ray is used as a specific X ray, and the insertion rate is 1 deg/min. Thereby, lithium ions are more smoothly inserted and extracted, and reactivity with the electrolytic solution is decreased. In some cases, the SnCoC-containing material has a phase containing a simple substance or part of the respective constituent elements in addition to the low crystalline or amorphous phase.

Whether or not the diffraction peak obtained by X-ray diffraction corresponds to the reaction phase capable of reacting with Li is allowed to be easily determined by comparison between X-ray diffraction charts before and after electrochemical reaction with Li. For example, if the position of the diffraction peak after electrochemical reaction with Li is changed from the position of the diffraction peak before the electrochemical reaction with Li, the obtained diffraction peak corresponds to the reaction phase capable of reacting with Li. In this case, for example, the diffraction peak of the low crystalline or amorphous reaction phase is seen in the range of 2θ=from 20 to 50 deg both inclusive. Such a reaction phase has, for example, the foregoing respective constituent elements, and the low crystalline or amorphous structure possibly results from existence of C mainly.

In the SnCoC-containing material, part or all of C as a constituent element are preferably bonded with a metal element or a metalloid element as other constituent element, since thereby cohesion or crystallization of Sn or the like is suppressed. The bonding state of elements is allowed to be checked by, for example, X-ray photoelectron spectroscopy (XPS). In a commercially available device, for example, as a soft X ray, Al-Kα ray, Mg-Kα ray, or the like is used. In the case where part or all of C are bonded with a metal element, a metalloid element, or the like, the peak of a synthetic wave of is orbit of C(Cls) is shown in a region lower than 284.5 eV. It is to be noted that in the device, energy calibration is made so that the peak of 4f orbit of Au atom (Au4f) is obtained in 84.0 eV. At this time, in general, since surface contamination carbon exists on the material surface, the peak of Cls of the surface contamination carbon is regarded as 284.8 eV, which is used as the energy standard. In XPS measurement, the waveform of the peak of Cls is obtained as a form including the peak of the surface contamination carbon and the peak of C in the SnCoC-containing material. Therefore, for example, analysis is made by using commercially available software to isolate both peaks from each other. In the waveform analysis, the position of a main peak existing on the lowest bound energy side is the energy standard (284.8 eV).

The SnCoC-containing material may further contain other constituent element as needed. Examples of other constituent elements include one, or two or more of Si, Fe, Ni, Cr, In, Nb, Ge, Ti, Mo, Al, P, Ga, and Bi.

In addition to the SnCoC-containing material, a material containing Sn, Co, Fe, and C as constituent elements (SnCoFeC-containing material) is also preferable. The composition of the SnCoFeC-containing material may be arbitrarily set. For example, a composition in which the Fe content is set small is as follows. That is, the C content is from 9.9 wt % to 29.7 wt % both inclusive, the Fe content is from 0.3 wt % to 5.9 wt % both inclusive, and the ratio of contents of Sn and Co (Co/(Sn+Co)) is from 30 wt % to 70 wt % both inclusive. Further, for example, a composition in which the Fe content is set large is as follows. That is, the C content is from 11.9 wt % to 29.7 wt % both inclusive, the ratio of contents of Sn, Co, and Fe ((Co+Fe)/(Sn+Co+Fe)) is from 26.4 wt % to 48.5 wt % both inclusive, and the ratio of contents of Co and Fe (Co/(Co+Fe)) is from 9.9 wt % to 79.5 wt % both inclusive. This is because, in such a composition range, a high energy density is obtained. The physical properties (half bandwidth and the like) of the SnCoFeC-containing material are similar to those of the foregoing SnCoC-containing material.

Further, as other anode material, for example, a metal oxide, a polymer compound, or the like may be used. Examples of the metal oxide include iron oxide, ruthenium oxide, and molybdenum oxide. Examples of the polymer compound include polyacetylene, polyaniline, and polypyrrole.

The anode active material layer 22B is formed by, for example, a coating method, a vapor-phase deposition method, a liquid-phase deposition method, a spraying method, a firing method (sintering method), or a combination of two or more of these methods. The coating method is a method in which, for example, after a powdery (particulate) anode active material is mixed with a binder or the like, the mixture is dispersed in a solvent such as an organic solvent, and the anode current collector is coated with the resultant. Examples of the vapor-phase deposition method include a physical deposition method and a chemical deposition method. Specifically, examples thereof include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method include an electrolytic plating method and an electroless plating method. The spraying method is a method in which an anode active material in a fused state or a semi-fused state is sprayed. The firing method is, for example, a method in which after the anode current collector is coated by a procedure similar to that of the coating method, heat treatment is performed at temperature higher than the melting point of the binder or the like. Examples of the firing method include a known technique such as an atmosphere firing method, a reactive firing method, and a hot press firing method.

[Separator]

The separator 23 separates the cathode 21 from the anode 22, and passes lithium ions while preventing current short circuit resulting from contact of both electrodes. The separator 23 is formed of, for example, a porous film made of a synthetic resin, ceramics, or the like. The separator 23 may be a laminated film in which two or more of porous films are layered. Examples of the synthetic resin include polytetrafluoroethylene, polypropylene, and polyethylene.

[Electrolytic Solution]

The separator 23 is impregnated with an electrolytic solution as a liquid electrolyte. In the electrolytic solution, an electrolyte salt is dissolved in a solvent. The electrolytic solution may contain other material such as an additive as needed.

The solvent contains one, or two or more of nonaqueous solvents such as an organic solvent. Examples of the nonaqueous solvents include ethylene carbonate, propylene carbonate, butylene carbonate, dimethyl carbonate, diethyl carbonate, ethyl methyl carbonate, methylpropyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, trimethyl methyl acetate, trimethyl ethyl acetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. By using such a nonaqueous solvent, a superior battery capacity, superior cycle characteristics, superior conservation characteristics, and the like are obtained.

Specially, one or more of ethylene carbonate, propylene carbonate, dimethyl carbonate, diethyl carbonate, and ethyl methyl carbonate are preferable, since thereby more superior characteristics are obtained. In this case, a combination of a high viscosity (high dielectric constant) solvent (for example, specific dielectric constant ∈≦30) such as ethylene carbonate and propylene carbonate and a low viscosity solvent (for example, viscosity≦1 mPa·s) such as dimethyl carbonate, ethylmethyl carbonate, and diethyl carbonate is more preferable. Thereby, dissociation property of the electrolyte salt and ion mobility are improved.

In particular, the solvent preferably contains a halogenated chain ester carbonate or a halogenated cyclic ester carbonate or both. This is because, since a stable film is thereby formed on the surface of the anode 22 at the time of charge and discharge, a decomposition reaction of the electrolytic solution is suppressed. The halogenated chain ester carbonate is a chain ester carbonate containing halogen as a constituent element (being obtained by substituting one or more of “H”s by halogen). The halogenated cyclic ester carbonate is a cyclic ester carbonate containing halogen as a constituent element (being obtained by substituting one or more of “H”s by halogen).

Though the halogen type is not particularly limited, specially, F, Cl, or Br is preferable, and F is more preferable, since thereby a higher effect is obtained than other halogens. The number of halogens is more preferably two than one, and further may be three or more, since thereby an ability to form a protective film is improved, a more rigid and stable film is formed, and thereby a decomposition reaction of the electrolytic solution is more suppressed.

Examples of the halogenated chain ester carbonate include fluoromethyl methyl carbonate, bis(fluoromethyl)carbonate, and difluoromethyl methyl carbonate. Examples of the halogenated cyclic ester carbonate include 4-fluoro-1,3-dioxolane-2-one and 4,5-difluoro-1,3-dioxolane-2-one. The halogenated cyclic ester carbonate includes a geometric isomer. Contents of the halogenated chain ester carbonate and the halogenated cyclic ester carbonate in the solvent are, for example, from 0.01 wt % to 50 wt % both inclusive.

Further, the solvent preferably contains an unsaturated carbon bond cyclic ester carbonate. This is because, since a stable film is thereby formed on the surface of the anode 22 at the time of charge and discharge, a decomposition reaction of the electrolytic solution is suppressed. The unsaturated carbon bond cyclic ester carbonate is a cyclic ester carbonate including one, or two or more unsaturated carbon bonds (being obtained by introducing an unsaturated carbon bond to an arbitrary location). Examples of the unsaturated carbon bond cyclic ester carbonate include vinylene carbonate and vinylethylene carbonate. Contents of the unsaturated carbon bond cyclic ester carbonate in the solvent is, for example, from 0.01 wt % to 10 wt % both inclusive.

Further, the solvent preferably contains sultone (cyclic sulfonic ester), since thereby chemical stability of the electrolytic solution is improved. Examples of sultone include propane sultone and propene sultone. The sultone content in the solvent is, for example, from 0.5 wt % to 5 wt % both inclusive.

Further, the solvent preferably contains an acid anhydride, since chemical stability of the electrolytic solution is thereby improved. Examples of the acid anhydride include a carboxylic anhydride, a disulfonic anhydride, and a carboxylic sulfonic anhydride. Examples of the carboxylic anhydride include succinic anhydride, glutaric anhydride, and maleic anhydride. Examples of the disulfonic anhydride include anhydrous ethane disulfonic acid and anhydrous propane disulfonic acid. Examples of the carboxylic sulfonic anhydride include anhydrous sulfobenzoic acid, anhydrous sulfopropionate, and anhydrous sulfobutyrate. The content of the acid anhydride in the solvent is, for example, from 0.5 wt % to 5 wt % both inclusive.

The electrolyte salt contains, for example, one, or two or more of light metal salts such as an Li salt. Examples of the Li salt include LiPF₆, LiBF₄, LiClO₄, LiAsF₆, LiB(C₆H₅)₄, LiCH₃SO₃, LiCF₃SO₃, LiAlCl₄, Li₂SiF₆, LiCl, and LiBr. Alternately, other type of Li salt may be used. By using such light metal salt, a superior battery capacity, superior cycle characteristics, superior conservation characteristics, and the like are obtained.

Specially, one, or two or more of LiPF₆, LiBF₄, LiClO₄, and LiAsF₆ are preferable, LiPF₆ or LiBF₄ is more preferable, and LiPF₆ is further more preferable, since thereby internal resistance is lowered, and more superior properties are obtained.

The content of the electrolyte salt is preferably from 0.3 mol/kg to 3.0 mol/kg both inclusive with respect to the solvent, since thereby high ion conductivity is obtained.

[Operation of Secondary Battery]

In the secondary battery, for example, at the time of charge, lithium ions extracted from the cathode 21 are inserted in the anode 22 through the electrolytic solution. Further, for example, at the time of discharge, lithium ions extracted from the anode 22 are inserted in the cathode 21 through the electrolytic solution.

[Method of Manufacturing Secondary Battery]

The secondary battery is manufactured, for example, by the following procedure.

First, the cathode 21 is formed. First, a cathode active material is mixed with a cathode binder, a cathode electric conductor, or the like as needed to prepare a cathode mixture. After that, the cathode mixture is dispersed in an organic solvent or the like to obtain a paste cathode mixture slurry. Subsequently, both surfaces of the cathode current collector 21A are coated with the cathode mixture slurry, which is dried to form the cathode active material layer 21B. Finally, the cathode active material layer 21B is compression-molded by using a rolling press machine or the like while being heated as needed. In this case, compression-molding may be repeated several times.

Next, the anode 22 is formed by a procedure similar to that of the foregoing cathode 21. In this case, an anode active material is mixed with an anode binder, an anode electric conductor, or the like as needed to prepare an anode mixture, which is subsequently dispersed in an organic solvent or the like to form a paste anode mixture slurry. Subsequently, both surfaces of the anode current collector 22A are coated with the anode mixture slurry, which is dried to form the anode active material layer 22B. After that, the anode active material layer 22B is compression-molded as needed.

Finally, the secondary battery is assembled by using the cathode 21 and the anode 22. First, the cathode lead 25 is attached to the cathode current collector 21A by using a welding method or the like, and the anode lead 26 is attached to the anode current collector 22A by using a welding method or the like. Subsequently, the cathode 21 and the anode 22 are layered with the separator 23 in between and are spirally wound, and thereby the spirally wound electrode body 20 is formed. After that, the center pin 24 is inserted in the center of the spirally wound electrode body. Subsequently, the spirally wound electrode body 20 is sandwiched between the pair of insulating plates 12 and 13, and is contained in the battery can 11. In this case, the end tip of the cathode lead 25 is attached to the safety valve mechanism 15 by using a welding method or the like, and the end tip of the anode lead 26 is attached to the battery can 11 by using a welding method or the like. Subsequently, the electrolytic solution is injected into the battery can 11, and the separator 23 is impregnated with the electrolytic solution. Finally, at the open end of the battery can 11, the battery cover 14, the safety valve mechanism 15, and the PTC device 16 are fixed by being swaged with the gasket 17.

[Function and Effect of Secondary Battery]

According to the cylindrical type secondary battery, the cathode 21 contains the foregoing active material as a cathode active material. Therefore, lowering of the discharge capacity due to crystallinity of the cathode active material is suppressed even at the time of charge and discharge in high load conditions. Therefore, a high discharge capacity is obtainable even in high load conditions.

[2-2. Electrode and Secondary Battery (Laminated Film Type)]

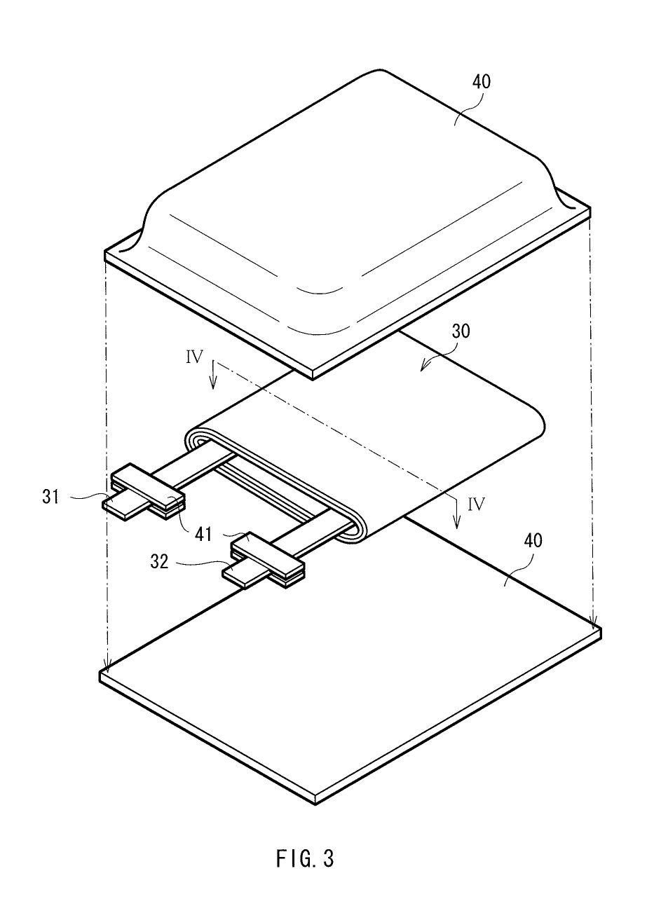

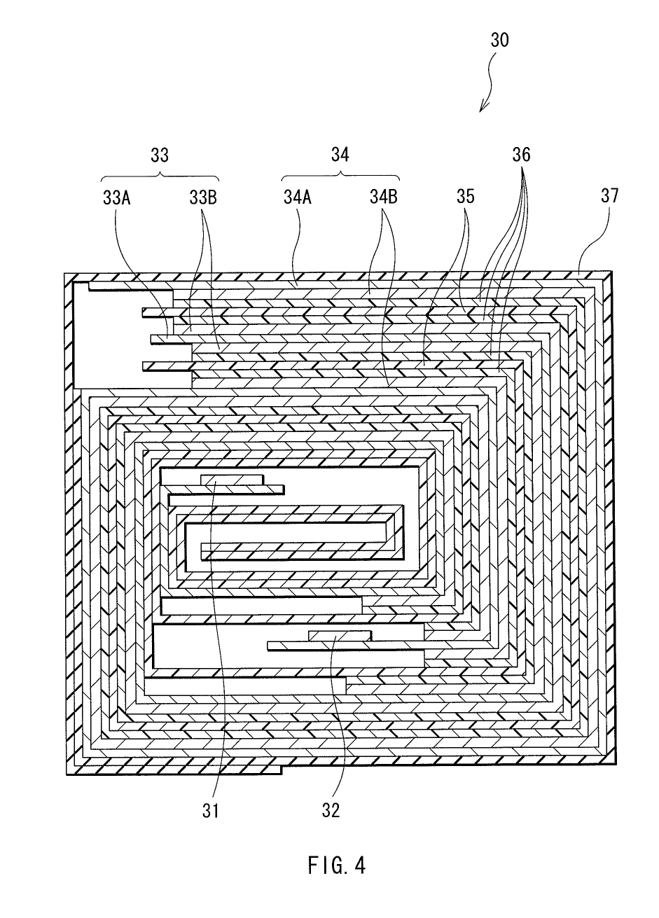

FIG. 3 illustrates an exploded perspective configuration of a laminated film type secondary battery. FIG. 4 illustrates an enlarged cross-section taken along a line IV-IV of a spirally wound electrode body 30 illustrated in FIG. 3. The secondary battery herein described is a lithium ion secondary battery as the cylindrical type secondary battery. In the following description, the elements of the cylindrical type secondary battery described above will be used as needed.

[Whole Structure of Secondary Battery]

In the secondary battery, the spirally wound electrode body 30 is mainly contained in a film-like outer package member 40. The spirally wound electrode body 30 is a spirally wound laminated body in which a cathode 33 and an anode 34 are layered with a separator 35 and an electrolyte layer 36 in between and are spirally wound. A cathode lead 31 is attached to the cathode 33, and an anode lead 32 is attached to the anode 34. The outermost periphery of the spirally wound electrode body 30 is protected by a protective tape 37.

The cathode lead 31 and the anode lead 32 are, for example, led out from inside to outside of the outer package member 40 in the same direction. The cathode lead 31 is made of, for example, a conductive material such as Al, and the anode lead 32 is made of, for example, a conducive material such as Cu, Ni, and stainless steel. These materials are in the shape of, for example, a thin plate or mesh.

The outer package member 40 is a laminated film in which, for example, a fusion bonding layer, a metal layer, and a surface protective layer are layered in this order. In the laminated film, for example, the respective outer edges of the fusion bonding layer of two films are bonded with each other by fusion bonding, an adhesive, or the like so that the fusion bonding layers and the spirally wound electrode body 30 are opposed to each other. Examples of the fusion bonding layer include a film made of polyethylene, polypropylene, or the like. Examples of the metal layer include an Al foil. Examples of the surface protective layer include a film made of nylon, polyethylene terephthalate, or the like.

Specially, as the outer package member 40, an aluminum laminated film in which a polyethylene film, an aluminum foil, and a nylon film are layered in this order is preferable. However, the outer package member 40 may be made of a laminated film having other laminated structure, a polymer film such as polypropylene, or a metal film.

An adhesive film 41 to protect from outside air intrusion is inserted between the outer package member 40, and the cathode lead 31 and the anode lead 32. The adhesive film 41 is made of a material having adhesion characteristics with respect to the cathode lead 31 and the anode lead 32. Examples of such a material include a polyolefin resin such as polyethylene, polypropylene, modified polyethylene, and modified polypropylene.

The cathode 33 has, for example, a cathode active material layer 33B on both surfaces of a cathode current collector 33A. In the anode 34, for example, an anode active material layer 34B is provided on both surfaces of an anode current collector 34A. The configurations of the cathode current collector 33A, the cathode active material layer 33B, the anode current collector 34A, and the anode active material layer 34B are respectively similar to the configurations of the cathode current collector 21A, the cathode active material layer 21B, the anode current collector 22A, and the anode active material layer 22B. Further, the configuration of the separator 35 is similar to the configuration of the separator 23.

In the electrolyte layer 36, an electrolytic solution is held by a polymer compound. The electrolyte layer 36 may contain other material such as an additive as needed. The electrolyte layer 36 is what we call a gel electrolyte, since thereby high ion conductivity (for example, 1 mS/cm or more at room temperature) is obtained and liquid leakage of the electrolytic solution is prevented.

Examples of the polymer compound include one, or two or more of polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, polycarbonate, and a copolymer of vinylidene fluoride and hexafluoro propylene. Specially, polyvinylidene fluoride or the copolymer of vinylidene fluoride and hexafluoro propylene is preferable, since such a polymer compound is electrochemically stable.

The composition of the electrolytic solution is similar to the composition of the cylindrical type secondary battery. However, in the electrolyte layer 36 as a gel electrolyte, a solvent of the electrolytic solution represents a wide concept including not only a liquid solvent but also a material having ion conductivity capable of dissociating the electrolyte salt. Therefore, in the case where a polymer compound having ion conductivity is used, the polymer compound is also included in the solvent.

Instead of the gel electrolyte layer 36, the electrolytic solution may be used as it is. In this case, the separator 35 is impregnated with the electrolytic solution.

[Operation of Secondary Battery]

In the secondary battery, for example, at the time of charge, lithium ions extracted from the cathode 33 are inserted in the anode 34 through the electrolyte layer 36. Meanwhile, for example, at the time of discharge, lithium ions extracted from the anode 34 are inserted in the cathode 33 through the electrolyte layer 36.

[Method of Manufacturing Secondary Battery]

The secondary battery including the gel electrolyte layer 36 is manufactured, for example, by the following three types of procedures.

In the first procedure, first, the cathode 33 and the anode 34 are formed by a formation procedure similar to that of the cathode 21 and the anode 22. In this case, the cathode 33 is formed by forming the cathode active material layer 33B on both surfaces of the cathode current collector 33A. Further, the anode 34 is formed by forming the anode active material layer 34B on both surfaces of the anode current collector 34A. Subsequently, a precursor solution containing an electrolytic solution, a polymer compound, an organic solvent, and the like is prepared. After that, the cathode 33 and the anode 34 are coated with the precursor solution to form the gel electrolyte layer 36. Subsequently, the cathode lead 31 is attached to the cathode current collector 33A by a welding method or the like and the anode lead 32 is attached to the anode current collector 34A by a welding method or the like. Subsequently, the cathode 33 and the anode 34 provided with the electrolyte layer 36 are layered with the separator 35 in between and are spirally wound to form the spirally wound electrode body 30. After that, the protective tape 37 is adhered to the outermost periphery thereof. Finally, after the spirally wound electrode body 30 is sandwiched between two pieces of film-like outer package members 40, outer edges of the outer package members 40 are bonded by a thermal fusion bonding method or the like to enclose the spirally wound electrode body 30 into the outer package members 40. In this case, the adhesive films 41 are inserted between the cathode lead 31 and the anode lead 32, and the outer package member 40.

In the second procedure, first, the cathode lead 31 is attached to the cathode 33, and the anode lead 32 is attached to the anode 34. Subsequently, the cathode 33 and the anode 34 are layered with the separator 35 in between and are spirally wound to form a spirally wound body as a precursor of the spirally wound electrode body 30. After that, the protective tape 37 is adhered to the outermost periphery thereof. Subsequently, after the spirally wound body is sandwiched between two pieces of the film-like outer package members 40, the outermost peripheries except for one side are adhered by using a thermal fusion bonding method or the like to obtain a pouched state, and the spirally wound body is contained in the pouch-like outer package member 40. Subsequently, a composition for electrolyte containing an electrolytic solution, a monomer as a raw material for the polymer compound, a polymerization initiator, and other materials such as a polymerization inhibitor as needed is prepared, which is injected into the pouch-like outer package member 40. After that, an opening section of the outer package member 40 is hermetically sealed by using a thermal fusion bonding method or the like. Finally, the monomer is thermally polymerized to obtain a polymer compound, and thereby the gel electrolyte layer 36 is formed.

In the third procedure, the spirally wound body is formed and contained in the pouch-like outer package member 40 in a manner similar to that of the foregoing second procedure, except that the separator 35 with both surfaces coated with a polymer compound is used first. Examples of the polymer compound with which the separator 35 is coated include a polymer (a homopolymer, a copolymer, a multicomponent copolymer, or the like) containing vinylidene fluoride as a component. Specific examples thereof include polyvinylidene fluoride, a binary copolymer containing vinylidene fluoride and hexafluoro propylene as a component, and a ternary copolymer containing vinylidene fluoride, hexafluoro propylene, and chlorotrifluoroethylene as a component. Together with the polymer containing vinylidene fluoride as a component, other one, or two or more of polymer compounds may be used. Subsequently, an electrolytic solution is prepared and injected into the outer package member 40. After that, the opening of the outer package member 40 is sealed by using a thermal fusion bonding method or the like. Finally, the resultant is heated while a weight is applied to the outer package member 40, and the separator 35 is adhered to the cathode 33 and the anode 34 with the polymer compound in between. Thereby, the polymer compound is impregnated with the electrolytic solution, and accordingly the polymer compound is gelated to form the electrolyte layer 36.

In the third procedure, battery swollenness is suppressed more than in the first procedure. Further, in the third procedure, the monomer as a raw material of the polymer compound, the organic solvent, and the like are less likely to be left in the electrolyte layer 36 compared to in the second procedure. Thus, the formation step of the polymer compound is favorably controlled. Therefore, sufficient adhesion characteristics are obtained between the cathode 33, the anode 34, and the separator 35, and the electrolyte layer 36.

[Function and Effect of Secondary Battery]

According to the laminated film type secondary battery, the cathode 33 contains the foregoing active material as a cathode active material. Therefore, a high discharge capacity is obtainable even in high load conditions as in the cylindrical type secondary battery.

[3. Applications of Secondary Battery]

Next, a description will be given of application examples of the foregoing secondary battery.

Applications of the secondary battery are not particularly limited as long as the secondary battery is used for a machine, a device, an instrument, an apparatus, a system (collective entity of a plurality of devices and the like), or the like that is allowed to use the secondary battery as a driving electric power source, an electric power storage source for electric power storage, or the like. In the case where the secondary battery is used as an electric power source, the secondary battery may be used as a main electric power source (electric power source used preferentially), or an auxiliary electric power source (electric power source used instead of a main electric power source or used being switched from the main electric power source).

Examples of applications of the secondary battery include mobile electronic devices such as a video camcoder, a digital still camera, a mobile phone, a notebook personal computer, a cordless phone, a headphone stereo, a portable radio, a portable television, and a personal digital assistant. Further examples thereof include a mobile lifestyle electric appliance such as an electric shaver; a memory device such as a backup electric power source and a memory card; an electric power tool such as an electric drill and an electric saw; a battery pack used as an electric power source of a notebook personal computer or the like; a medical electronic device such as a pacemaker and a hearing aid; an electric vehicle such as an electric automobile (including a hybrid automobile); and an electric power storage system such as a home battery system for storing electric power for emergency or the like. It is needless to say that an application other than the foregoing applications may be adopted.

Specially, the secondary battery is effectively applicable to the battery pack, the electric vehicle, the electric power storage system, the electric power tool, the electronic device, or the like. In these applications, since superior battery characteristics are demanded, the characteristics are allowed to be effectively improved by using the secondary battery according to the embodiment of the present application. The battery pack is an electric power source using a secondary battery, and is what we call an assembled battery or the like. The electric vehicle is a vehicle that works (runs) by using a secondary battery as a driving electric power source. As described above, an automobile including a drive source other than a secondary battery (hybrid automobile or the like) may be included. The electric power storage system is a system using a secondary battery as an electric power storage source. For example, in a home electric power storage system, electric power is stored in the secondary battery as an electric power storage source, and the electric power is consumed as needed. Thereby, home electric products and the like become usable. The electric power tool is a tool in which a moving part (for example, a drill or the like) is moved by using a secondary battery as a driving electric power source. The electronic device is a device executing various functions by using a secondary battery as a driving electric power source.

A description will be specifically given of some application examples of the secondary battery. Configurations of the respective application examples explained below are only examples, and may be changed as appropriate.

[3-1. Battery Pack]

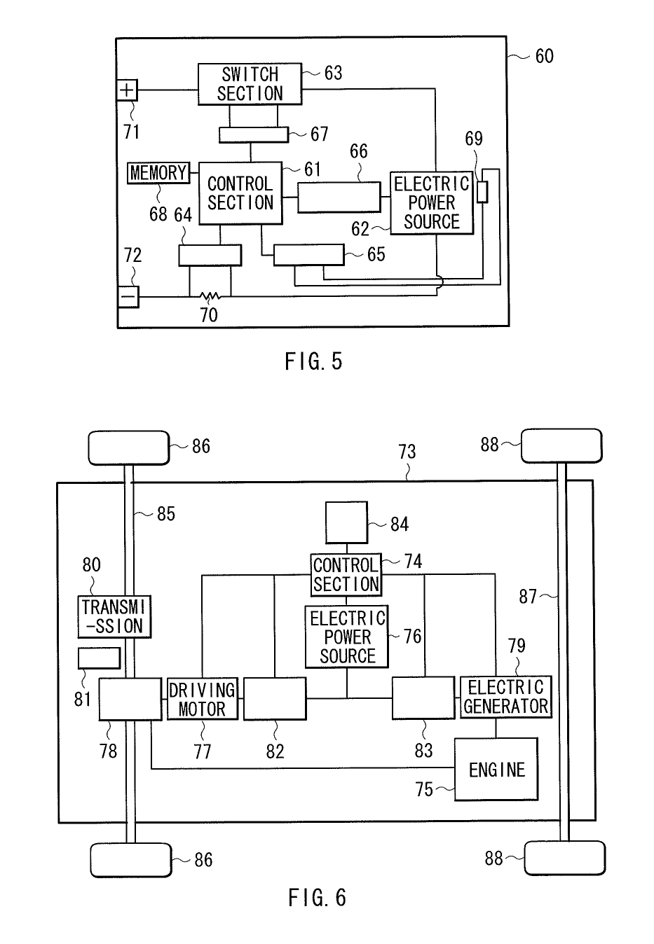

FIG. 5 illustrates a block configuration of a battery pack. For example, as illustrated in FIG. 5, the battery pack includes a control section 61, an electric power source 62, a switch section 63, a current measurement section 64, a temperature detection section 65, a voltage detection section 66, a switch control section 67, a memory 68, a temperature detection device 69, a current detection resistance 70, a cathode terminal 71, and an anode terminal 72 in a housing 60 made of a plastic material or the like.

The control section 61 controls operation of the whole battery pack (including a usage state of the electric power source 62), and includes, for example, a central processing unit (CPU) or the like. The electric power source 62 includes one, or two or more secondary batteries (not illustrated). The electric power source 62 is, for example, an assembled battery including two or more secondary batteries. Connection type thereof may be series-connected type, may be parallel-connected type, or a mixed type thereof. As an example, the electric power source 62 includes six secondary batteries connected in a manner of dual-parallel and three-series.

The switch section 63 switches the usage state of the electric power source 62 (whether or not the electric power source 62 is connectable to an external device) according to a direction of the control section 61. The switch section 63 includes, for example, a charge control switch, a discharge control switch, a charging diode, a discharging diode, and the like (not illustrated). The charge control switch and the discharge control switch are, for example, semiconductor switches such as a field-effect transistor (MOSFET) using metal oxide semiconductor.

The current measurement section 64 is intended to measure a current by using the current detection resistance 70, and output a measurement result thereof to the control section 61. The temperature detection section 65 is intended to measure temperature by using the temperature detection device 69, and output a measurement result thereof to the control section 61. The temperature measurement result is used for, for example, a case in which the control section 61 controls charge and discharge at the time of abnormal heat generation or a case in which the control section 61 performs a correction processing at the time of calculating a remaining capacity. The voltage detection section 66 is intended to measure a voltage of the secondary battery in the electric power source 62, performs analog/digital conversion (A/D conversion) on the measured voltage, and supplies the resultant to the control section 61.

The switch control section 67 controls operation of the switch section 63 according to signals inputted from the current measurement section 64 and the voltage measurement section 66.

The switch control section 67 executes control so that a charge current is prevented from flowing in a current path of the electric power source 62 by disconnecting the switch section 63 (charge control switch) in the case where, for example, a battery voltage reaches an overcharge detection voltage. Thereby, in the electric power source 62, only discharge is allowed to be performed through the discharging diode. It is to be noted that, for example, in the case where a large current flows at the time of charge, the switch section 67 blocks the charge current.

The switch control section 67 executes control so that a discharge current is prevented from flowing in the current path of the electric power source 62 by disconnecting the switch section 67 (discharge control switch) in the case where, for example, a battery voltage reaches an overdischarge detection voltage. Thereby, in the electric power source 62, only charge is allowed to be performed through the charging diode. For example, in the case where a large current flows at the time of discharge, the switch section 67 blocks the discharge current.

In the secondary battery, for example, the overcharge detection voltage is 4.20 V±0.05 V, and the over-discharge detection voltage is 2.4. V±0.1 V

The memory 68 is, for example, an EEPROM as a nonvolatile memory or the like. The memory 68 stores, for example, numerical values calculated by the control section 61 and information of the secondary battery measured in a manufacturing step (for example, an internal resistance in the initial state or the like). In the case where the memory 68 stores a full charge capacity of the secondary battery, the control section 10 is allowed to comprehend information such as a remaining capacity.

The temperature detection device 69 is intended to measure temperature of the electric power source 62, and output a measurement result thereof to the control section 61. The temperature detection device 69 is, for example, a thermistor or the like.

The cathode terminal 71 and the anode terminal 72 are terminals connected to an external device (for example, a notebook personal computer or the like) driven by using the battery pack or an external device (for example, a battery charger or the like) used for charging the battery pack. The electric power source 62 is charged and discharged through the cathode terminal 71 and the anode terminal 72.

[3-2. Electric Vehicle]

FIG. 6 illustrates a block configuration of a hybrid automobile as an example of electric vehicles. For example, as illustrated in FIG. 6, the electric vehicle includes a control section 74, an engine 75, an electric power source 76, a driving motor 77, a differential 78, an electric generator 79, a transmission 80, a clutch 81, inverters 82 and 83, and various sensors 84 in a housing 73 made of a metal. In addition, the electric vehicle includes, for example, a front drive axis 85 and a front tire 86 that are connected to the differential 78 and the transmission 80, and a rear drive axis 87 and a rear tire 88.

The electric vehicle is runnable by using one of the engine 75 and the motor 77 as a drive source. The engine 75 is a main power source, and is, for example, a petrol engine. In the case where the engine 75 is used as a power source, drive power (torque) of the engine 75 is transferred to the front tire 86 or the rear tire 88 through the differential 78, the transmission 80, and the clutch 81 as drive sections, for example. The torque of the engine 75 is also transferred to the electric generator 79. Due to the torque, the electric generator 79 generates alternating-current electric power. The alternating-current electric power is converted to direct-current electric power through the inverter 83, and the converted power is stored in the electric power source 76. Meanwhile, in the case where the motor 77 as a conversion section is used as a drive source, electric power (direct-current electric power) supplied from the electric power source 76 is converted to alternating-current electric power through the inverter 82. The motor 77 is driven by the alternating-current electric power. Drive power (torque) obtained by converting the electric power by the motor 77 is transferred to the front tire 86 or the rear tire 88 through the differential 78, the transmission 80, and the clutch 81 as the drive sections, for example.

It is to be noted that, alternately, the following mechanism may be adopted. In the mechanism, in the case where speed of the electric vehicle is reduced by an unillustrated brake mechanism, resistance at the time of speed reduction is transferred to the motor 77 as torque, and the motor 77 generates alternating-current electric power by the torque. It is preferable that the alternating-current electric power be converted to the direct-current electric power through the inverter 82, and the direct-current regenerative electric power be stored in the electric power source 76.

The control section 74 is intended to control operation of the whole electric vehicle, and, for example, includes a CPU and the like. The electric power source 76 includes one, or two or more secondary batteries (not illustrated). Alternately, the electric power source 76 may be connected to an external electric power source, and electric power may be stored by receiving the electric power from the external electric power source. The various sensors 84 are used, for example, for controlling the number of revolutions of the engine 75 or controlling opening level of an unshown throttle valve (throttle opening level). The various sensors 84 include, for example, a speed sensor, an acceleration sensor, an engine frequency sensor, and the like.

The description has been hereinbefore given of the hybrid automobile as an electric vehicle. However, examples of the electric vehicles may include a vehicle (electric automobile) working by using only the electric power source 76 and the motor 77 without using the engine 75.

[3-3. Electric Power Storage System]

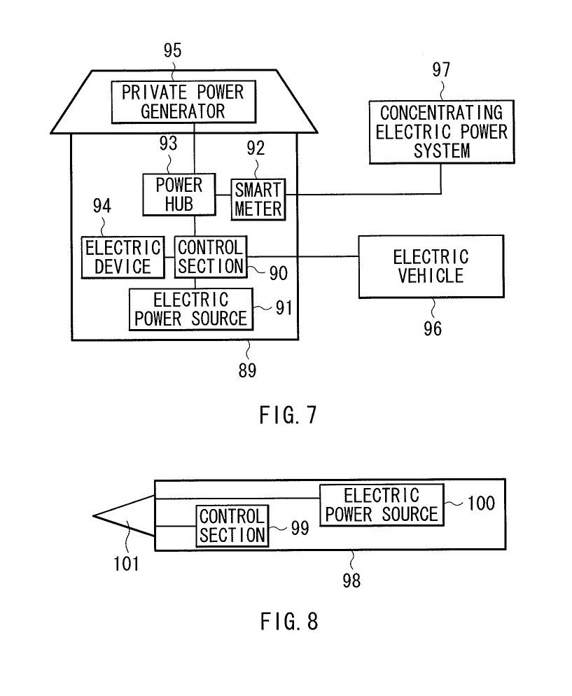

FIG. 7 illustrates a block configuration of an electric power storage system. For example, as illustrated in FIG. 7, the electric power storage system includes a control section 90, an electric power source 91, a smart meter 92, and a power hub 93 inside a house 89 such as a general residence and a commercial building.

In this case, the electric power source 91 is connected to, for example, an electric device 94 arranged inside the house 89, and is connectable to an electric vehicle 96 parked outside of the house 89. Further, for example, the electric power source 91 is connected to a private power generator 95 arranged inside the house 89 through the power hub 93, and is connectable to an external concentrating electric power system 97 thorough the smart meter 92 and the power hub 93.

The electric device 94 includes, for example, one, or two or more home electric appliances such as a fridge, an air conditioner, a television, and a water heater. The private power generator 95 is one, or two or more of a solar power generator, a wind-power generator, and the like. The electric vehicle 96 is one, or two or more of an electric automobile, an electric motorcycle, a hybrid automobile, and the like. The concentrating electric power system 97 is, for example, one, or two or more of a thermal power plant, an atomic power plant, a hydraulic power plant, a wind-power plant, and the like.

The control section 90 is intended to control operation of the whole electric power storage system (including a usage state of the electric power source 91), and, for example, includes a CPU and the like. The electric power source 91 includes one, or two or more secondary batteries (not illustrated). The smart meter 92 is, for example, an electric power meter compatible with a network arranged in the house 89 demanding electric power, and is communicable with an electric power supplier. Accordingly, for example, while the smart meter 92 communicates with external as needed, the smart meter 92 is allowed to control balance of supply and demand in the house 89 and supply energy effectively and stably.

In the electric power storage system, for example, electric power is stored in the electric power source 91 from the concentrating electric power system 97 as an external electric power source through the smart meter 92 and the power hub 93, and electric power is stored in the electric power source 91 from the solar power generator 95 as an independent electric power source through the power hub 93. As needed, the electric power stored in the electric power source 91 is supplied to the electric device 94 or the electric vehicle 96 according to a direction of the control section 90. Therefore, the electric device 94 becomes operable, and the electric vehicle 96 becomes chargeable. That is, the electric power storage system is a system capable of storing and supplying electric power in the house 89 by using the electric power source 91.

The electric power stored in the electric power source 91 is arbitrarily usable. Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

The foregoing electric power storage system may be arranged for each household (family unit), or may be arranged for a plurality of households (family units).

[3-4. Electric Power Tool]

FIG. 8 illustrates a block configuration of an electric power tool. For example, as illustrated in FIG. 8, the electric power tool is an electric drill, and includes a control section 99 and an electric power source 100 in a tool body 98 made of a plastic material or the like. For example, a drill section 101 as a movable section is attached to the tool body 98 in an operable (rotatable) manner.

The control section 99 controls operation of the whole electric power tool (including usage state of the electric power source 100), and includes, for example, a central processing unit (CPU) or the like. The electric power source 100 includes one, or two or more secondary batteries (not illustrated). The control section 99 executes control so that electric power is supplied from the electric power source 100 to the drill section 101 as needed according to operation of an unshown operation switch to operate the drill section 101.

### EXAMPLES

Specific Examples according to the embodiment of the present disclosure will be described in detail.

### Examples 1-1 to 1-125

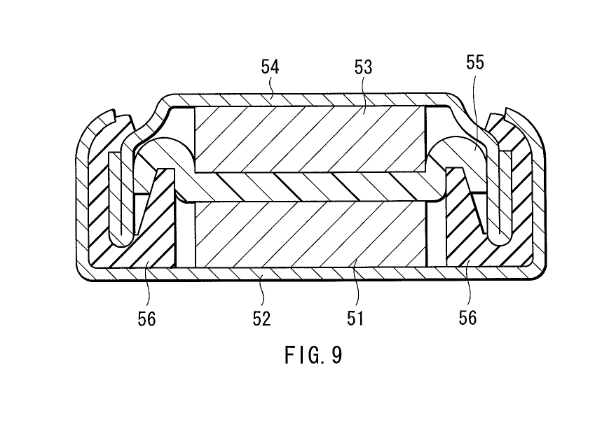

A coin type secondary battery (lithium ion secondary battery) illustrated in FIG. 9 was fabricated by the following procedure.

In obtaining a cathode active material, first, as raw materials, lithium phosphate powder, iron phosphate powder, and manganese phosphate powder were prepared. Subsequently, after the raw material powder was mixed, the mixture was dispersed in pure water to obtain a solution. Subsequently, the solution was sprayed by using a spray drying method in a high temperature environment at 200 deg C. to obtain a powdery cathode active material precursor (LiMn_{0.75}Fe_{0.25}PO₄). After that, the resultant was heated at 200 deg C. Subsequently, the powdery cathode active material precursor was compressed by using a tablet molding machine to obtain a pellet-like molded product. In this case, a thickness of the molded product was 6 μm, and density thereof was changed as illustrated in Table 1 to Table 5. Subsequently, the molded product of the cathode active material precursor was fired at 600 deg C. under an atmosphere of N₂ gas. Finally, the molded product of the cathode active material precursor was pulverized by using a ball mill to obtain a powdery cathode active material. In this case, by adjusting pulverization intensity and pulverization time, the particle size of the pulverized cathode active material (median diameter (D50) of primary particles) was changed as illustrated in Table 1 to Table 5. The median diameter (D90) of the cathode active material (secondary particles) used for fabricating the secondary battery was as illustrated in Table 1 to Table 5.

In forming a test electrode 51, first, 90.8 parts by mass of the cathode active material (LiMn_{03.75}Fe_{0.25}PO₄), 5 parts by mass of a cathode binder (polyvinylidene fluoride: PVDF), and 4.2 parts by mass of a cathode electric conductor (graphite) were mixed to obtain a cathode mixture. Subsequently, the cathode mixture was dispersed in NMP as an extra amount to obtain a paste cathode mixture slurry. Subsequently, one surface of a cathode current collector (Al foil, thickness: 15 μm) was coated with the cathode mixture slurry by using a coater, and the resultant was dried to form a cathode active material layer. Finally, the cathode active material layer was compression-molded by using a roll pressing machine, and the resultant was subsequently punched out into a pellet. A mercury penetration amount with respect to the cathode active material layer was measured by using a mercury porosimeter (AutoPore 9500 series available from Micromeritics Instrument Corporation). Maximum peak pore diameters were as illustrated in Table 1 to Table 5.

In forming the counter electrode 53, first, 95 parts by mass of an anode active material (graphite) and 5 parts by mass of an anode binder (PVDF) were mixed to obtain an anode mixture. After that, the anode mixture was dispersed in NMP as an extra amount to obtain a paste anode mixture slurry. Subsequently, one surface of an anode current collector (Cu foil, thickness: 15 μm) was coated with the anode mixture slurry by using a coater, and the resultant was subsequently dried to form an anode active material layer. After that, the anode active material layer was compression-molded by using a roll pressing machine, and the resultant was subsequently punched out into a pellet.

In preparing an electrolytic solution, ethylene carbonate (EC), ethylmethyl carbonate (EMC), and dimethyl carbonate (DMC) as a solvent were mixed, and LiPF₆ as an electrolyte salt was subsequently dissolved in the resultant mixture. In this case, the solvent mixture ratio (volume ratio) was EC:EMC:DMC=20:20:60, and the content of the electrolyte salt with respect to the solvent was 1 mol/dm³ (=1 mol/l).

In assembling the secondary battery, first, the test electrode 51 was contained in an outer package can 52, and the counter electrode 53 was contained in an outer package cup 54. Subsequently, the outer package can 52 and an outer package cup 54 were layered so that the cathode active material layer and the anode active material layer were opposed to each other with a separator 55 impregnated with the electrolytic solution (polyethylene, thickness: 23 μm) in between. Finally, the outer package can 52 and the outer package cup 54 were swaged with a gasket 56 in between. Thereby, a coin type secondary battery (diameter: 20 mm, height 1.6 mm) was completed.

In examining load characteristics of the secondary battery, results illustrated in Table 1 to Table 5 were obtained. In examining the load characteristics, the secondary battery was charged and discharged in a constant temperature bath at 25 deg C., and a discharge capacity (mAh/g) was measured. At the time of charge, after constant current charge was performed at a current density of 0.3 mA (corresponding to 0.1 C), the constant current charge was changed to constant voltage charge at the time when a battery voltage reached 4.2 V. At the time of discharge, constant current discharge was performed at a current density of 15 mA (corresponding to 5 C) until the battery voltage reached 3 V. “0.1 C” means a current value at which a battery capacity (theoretical capacity) is completely discharged in 10 hours. Meanwhile, “5 C” means a current value at which the battery capacity is completely discharged in 0.2 hour.

TABLE 1
Cathode active material: LiMn_{0.75}Fe_{0.25}PO₄

| | | | | Half | | |
|---|---|---|---|---|---|---|
| | | | | band- | Pore | Discharge |
| | Density | D50 | D90 | width | diameter | capacity |
| | (mg/cm³) | (μm) | (μm) | (deg) | (nm) | (mAh/g) |
| Example 1-1 | 0.5 | 5.0 | 10.5 | 0.14 | 0.060 | 45 |
| Example 1-2 | | | | 0.15 | | 80 |
| Example 1-3 | | | | 0.21 | | 106 |
| Example 1-4 | | | | 0.24 | | 83 |
| Example 1-5 | | | | 0.25 | | 44 |
| Example 1-6 | | 9.0 | 20.1 | 0.14 | | 50 |
| Example 1-7 | | | | 0.15 | | 85 |
| Example 1-8 | | | | 0.21 | | 110 |
| Example 1-9 | | | | 0.24 | | 85 |
| Example 1- | | | | 0.25 | | 50 |
| 10 | | | | | | |
| Example 1- | | 14.0 | 30.0 | 0.14 | | 55 |
| 11 | | | | | | |
| Example 1- | | | | 0.15 | | 90 |
| 12 | | | | | | |
| Example 1- | | | | 0.21 | | 115 |
| 13 | | | | | | |
| Example 1- | | | | 0.24 | | 88 |
| 14 | | | | | | |
| Example 1- | | | | 0.25 | | 53 |
| 15 | | | | | | |
| Example 1- | | 30.0 | 60.0 | 0.14 | | 40 |
| 16 | | | | | | |
| Example 1- | | | | 0.15 | | 82 |
| 17 | | | | | | |
| Example 1- | | | | 0.21 | | 95 |
| 18 | | | | | | |
| Example 1- | | | | 0.24 | | 85 |
| 19 | | | | | | |
| Example 1- | | | | 0.25 | | 40 |
| 20 | | | | | | |
| Example 1- | | 45.0 | 90.0 | 0.14 | | 25 |
| 21 | | | | | | |
| Example 1- | | | | 0.15 | | 40 |
| 22 | | | | | | |
| Example 1- | | | | 0.21 | | 50 |
| 23 | | | | | | |
| Example 1- | | | | 0.24 | | 41 |
| 24 | | | | | | |
| Example 1- | | | | 0.25 | | 10 |
| 25 | | | | | | |

TABLE 2
Cathode active material: LiMn_{0.75}Fe_{0.25}PO₄

| | | | | Half | | |
|---|---|---|---|---|---|---|
| | | | | band- | Pore | Discharge |
| | Density | D50 | D90 | width | diameter | capacity |
| | (mg/cm³) | (μm) | (μm) | (deg) | (nm) | (mAh/g) |
| Example 1- | 1.0 | 5.0 | 10.5 | 0.14 | 0.051 | 50 |
| 26 | | | | | | |
| Example 1- | | | | 0.15 | | 88 |
| 27 | | | | | | |
| Example 1- | | | | 0.21 | | 112 |
| 28 | | | | | | |
| Example 1- | | | | 0.24 | | 86 |
| 29 | | | | | | |
| Example 1- | | | | 0.25 | | 46 |
| 30 | | | | | | |
| Example 1- | | 9.0 | 20.1 | 0.14 | | 55 |
| 31 | | | | | | |
| Example 1- | | | | 0.15 | | 93 |
| 32 | | | | | | |
| Example 1- | | | | 0.21 | | 116 |
| 33 | | | | | | |
| Example 1- | | | | 0.24 | | 88 |
| 34 | | | | | | |
| Example 1- | | | | 0.25 | | 52 |
| 35 | | | | | | |
| Example 1- | | 14.0 | 30.0 | 0.14 | | 50 |
| 36 | | | | | | |
| Example 1- | | | | 0.15 | | 88 |
| 37 | | | | | | |
| Example 1- | | | | 0.21 | | 111 |
| 38 | | | | | | |
| Example 1- | | | | 0.24 | | 85 |
| 39 | | | | | | |
| Example 1- | | | | 0.25 | | 49 |
| 40 | | | | | | |
| Example 1- | | 30.0 | 60.0 | 0.14 | | 35 |
| 41 | | | | | | |
| Example 1- | | | | 0.15 | | 84 |
| 42 | | | | | | |
| Example 1- | | | | 0.21 | | 106 |
| 43 | | | | | | |
| Example 1- | | | | 0.24 | | 98 |
| 44 | | | | | | |
| Example 1- | | | | 0.25 | | 36 |
| 45 | | | | | | |
| Example 1- | | 45.0 | 90.0 | 0.14 | | 5 |
| 46 | | | | | | |
| Example 1- | | | | 0.15 | | 24 |
| 47 | | | | | | |
| Example 1- | | | | 0.21 | | 41 |
| 48 | | | | | | |
| Example 1- | | | | 0.24 | | 51 |
| 49 | | | | | | |
| Example 1- | | | | 0.25 | | 15 |
| 50 | | | | | | |

TABLE 3
Cathode active material: LiMn_{0.75}Fe_{0.25}PO₄

| | | | | Half | | |
|---|---|---|---|---|---|---|
| | | | | band- | Pore | Discharge |
| | Density | D50 | D90 | width | diameter | capacity |
| | (mg/cm³) | (μm) | (μm) | (deg) | (nm) | (mAh/g) |
| Example 1- | 1.5 | 5.0 | 10.5 | 0.14 | 0.031 | 44 |
| 51 | | | | | | |
| Example 1- | | | | 0.15 | | 84 |
| 52 | | | | | | |
| Example 1- | | | | 0.21 | | 105 |
| 53 | | | | | | |
| Example 1- | | | | 0.24 | | 83 |
| 54 | | | | | | |
| Example 1- | | | | 0.25 | | 35 |
| 55 | | | | | | |
| Example 1- | | 9.0 | 20.1 | 0.14 | | 44 |
| 56 | | | | | | |
| Example 1- | | | | 0.15 | | 84 |
| 57 | | | | | | |
| Example 1- | | | | 0.21 | | 105 |
| 58 | | | | | | |
| Example 1- | | | | 0.24 | | 83 |
| 59 | | | | | | |
| Example 1- | | | | 0.25 | | 35 |
| 60 | | | | | | |
| Example 1- | | 14.0 | 30.0 | 0.14 | | 44 |
| 61 | | | | | | |
| Example 1- | | | | 0.15 | | 84 |
| 62 | | | | | | |
| Example 1- | | | | 0.21 | | 105 |
| 63 | | | | | | |
| Example 1- | | | | 0.24 | | 83 |
| 64 | | | | | | |
| Example 1- | | | | 0.25 | | 35 |
| 65 | | | | | | |
| Example 1- | | 30.0 | 60.0 | 0.14 | | 44 |
| 66 | | | | | | |
| Example 1- | | | | 0.15 | | 84 |
| 67 | | | | | | |
| Example 1- | | | | 0.21 | | 105 |
| 68 | | | | | | |
| Example 1- | | | | 0.24 | | 83 |
| 69 | | | | | | |
| Example 1- | | | | 0.25 | | 35 |
| 70 | | | | | | |
| Example 1- | | 45.0 | 90.0 | 0.14 | | 14 |
| 71 | | | | | | |
| Example 1- | | | | 0.15 | | 34 |
| 72 | | | | | | |
| Example 1- | | | | 0.21 | | 40 |
| 73 | | | | | | |
| Example 1- | | | | 0.24 | | 36 |
| 74 | | | | | | |
| Example 1- | | | | 0.25 | | 19 |
| 75 | | | | | | |

TABLE 4
Cathode active material: LiMn_{0.75}Fe_{0.25}PO₄

| | | | | Half | | |
|---|---|---|---|---|---|---|
| | | | | band- | Pore | Discharge |
| | Density | D50 | D90 | width | diameter | capacity |
| | (mg/cm³) | (μm) | (μm) | (deg) | (nm) | (mAh/g) |
| Example 1- | 2.3 | 5.0 | 10.5 | 0.14 | 0.023 | 41 |
| 76 | | | | | | |
| Example 1- | | | | 0.15 | | 83 |
| 77 | | | | | | |
| Example 1- | | | | 0.21 | | 101 |
| 78 | | | | | | |
| Example 1- | | | | 0.24 | | 80 |
| 79 | | | | | | |
| Example 1- | | | | 0.25 | | 20 |
| 80 | | | | | | |
| Example 1- | | 9.0 | 20.1 | 0.14 | | 46 |
| 81 | | | | | | |
| Example 1- | | | | 0.15 | | 88 |
| 82 | | | | | | |
| Example 1- | | | | 0.21 | | 105 |
| 83 | | | | | | |
| Example 1- | | | | 0.24 | | 83 |
| 84 | | | | | | |
| Example 1- | | | | 0.25 | | 26 |
| 85 | | | | | | |
| Example 1- | | 14.0 | 30.0 | 0.14 | | 40 |
| 86 | | | | | | |
| Example 1- | | | | 0.15 | | 81 |
| 87 | | | | | | |
| Example 1- | | | | 0.21 | | 100 |
| 88 | | | | | | |
| Example 1- | | | | 0.24 | | 80 |
| 89 | | | | | | |
| Example 1- | | | | 0.25 | | 23 |
| 90 | | | | | | |
| Example 1- | | 30.0 | 60.0 | 0.14 | | 28 |
| 91 | | | | | | |
| Example 1- | | | | 0.15 | | 97 |
| 92 | | | | | | |
| Example 1- | | | | 0.21 | | 95 |
| 93 | | | | | | |
| Example 1- | | | | 0.24 | | 93 |
| 94 | | | | | | |
| Example 1- | | | | 0.25 | | 10 |
| 95 | | | | | | |
| Example 1- | | 45.0 | 90.0 | 0.14 | | 8 |
| 96 | | | | | | |
| Example 1- | | | | 0.15 | | 22 |
| 97 | | | | | | |
| Example 1- | | | | 0.21 | | 30 |
| 98 | | | | | | |
| Example 1- | | | | 0.24 | | 43 |
| 99 | | | | | | |
| Example 1- | | | | 0.25 | | 3 |
| 100 | | | | | | |

TABLE 5
Cathode active material: LiMn_{0.75}Fe_{0.25}PO₄

| | | | | Half | | |
|---|---|---|---|---|---|---|
| | | | | band- | Pore | Discharge |
| | Density | D50 | D90 | width | diameter | capacity |
| | (mg/cm³) | (μm) | (μm) | (deg) | (nm) | (mAh/g) |
| Example 1-101 | 2.5 | 5.0 | 10.5 | 0.14 | 0.019 | 10 |
| Example 1-102 | | | | 0.15 | | 30 |
| Example 1-103 | | | | 0.21 | | 35 |
| Example 1-104 | | | | 0.24 | | 36 |
| Example 1-105 | | | | 0.25 | | 20 |
| Example 1-106 | | 9.0 | 20.1 | 0.14 | | 15 |
| Example 1-107 | | | | 0.15 | | 42 |
| Example 1-108 | | | | 0.21 | | 40 |
| Example 1-109 | | | | 0.24 | | 41 |
| Example 1-110 | | | | 0.25 | | 26 |
| Example 1-111 | | 14.0 | 30.0 | 0.14 | | 13 |
| Example 1-112 | | | | 0.15 | | 40 |
| Example 1-113 | | | | 0.21 | | 45 |
| Example 1-114 | | | | 0.24 | | 32 |
| Example 1-115 | | | | 0.25 | | 5 |
| Example 1-116 | | 30.0 | 60.0 | 0.14 | | 8 |
| Example 1-117 | | | | 0.15 | | 20 |
| Example 1-118 | | | | 0.21 | | 30 |
| Example 1-119 | | | | 0.24 | | 22 |
| Example 1-120 | | | | 0.25 | | 3 |
| Example 1-121 | | 45.0 | 90.0 | 0.14 | | 1 |
| Example 1-122 | | | | 0.15 | | 2 |
| Example 1-123 | | | | 0.21 | | 3 |
| Example 1-124 | | | | 0.24 | | 2 |
| Example 1-125 | | | | 0.25 | | 2 |

In the case where manufacturing conditions (density and median diameter) and physical property conditions (half bandwidth) of the cathode active material were changed, discharge capacities in high load conditions were changed accordingly. In this case, in the case where the density was from 0.5 mg/cm³ to 2.3 mg/cm³ both inclusive and the pore diameter was from 0.023 μm to 0.06 μm both inclusive, the discharge capacity was higher than that in the case that the density and the pore diameter were out of the foregoing ranges. In the case where compression molding was not performed (density: 0 cm³), the test electrode 51 was not allowed to be formed, and therefore a discharge capacity was not allowed to be measured. Further, in the case where density was in the foregoing range, if the median diameter (D50) was from 5 μm to 30 μm both inclusive, and the median diameter (D90) was from 10.5 μm to 60 μm both inclusive, the discharge capacity was higher than that in the case that the density and the median diameters were out of ranges. Further, in the case where the density and the median diameters (D50 and D90) were within the foregoing ranges, if a half bandwidth was from 0.15 deg to 0.24 deg both inclusive, a discharge capacity was still higher than that in the case that the density and the median diameters (D50 and D90) were out of the foregoing ranges. In the case where a thickness of the molded product was larger than 6 μm, the foregoing physical property conditions (half bandwidth) were not obtained due to firing unevenness.

From the results of Table 1 to Table 5, it was confirmed as follows. That is, in the case where olivine Li phosphate represented by Formula (1) was used, if the median diameter (D90) was from 10.5 μm to 60 μm both inclusive and the half bandwidth was from 0.15 deg to 0.24 deg both inclusive, load characteristics were improved.

The present application has been described with reference to the embodiment and the examples. However, the present application is not limited to the foregoing aspects described therein, and various modifications may be made. For example, while the description has been given of the case in which the anode capacity is expressed by insertion and extraction of lithium ions, applicable aspects are not limited thereto. The present application is also applicable to a case in which an anode capacity includes a capacity due to inserting and extracting lithium ions and a capacity due to precipitation and dissolution of Li metal, and the anode capacity is expressed by the sum of these capacities. In this case, an anode material capable of inserting and extracting lithium ions is used as an anode active material, and a chargeable capacity of the anode material is set to a smaller value than that of a discharge capacity of the cathode.

Further, the description has been given of the case in which the battery structure is the cylindrical type or the laminated film type, and the battery device has the spirally wound structure. However, applicable structures are not limited thereto. The present application is also applicable to a case in which a battery structure is a rectangular type, a button type, or the like, or a case in which the battery device has a laminated structure or the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a cathode including an active material;
an anode; and
an electrolytic solution, wherein the active material has a composition represented by Formula (1) described below,
a median diameter (D90) of the active material is from about 10.5 micrometers to about 60 micrometers both inclusive, the median diameter (D90) being measured by a laser diffraction method, and
a half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method,
LiₐMn_{b}Fe_{c}M_{d}PO₄ (1)
where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

2. The secondary battery according to claim 1, wherein the active material has a composition represented by Formula (2) described below,
LiMn_{b1}Fe_{c1}PO₄ (2)
where 0<b1<1, 0<c1<1, and b1+c1=1 are established.

3. The secondary battery according to claim 1, wherein
the cathode includes an active material layer including the active material, and
a maximum peak pore diameter of percentage change of a mercury penetration amount with respect to the active material layer is from about 0.023 micrometers to about 0.06 micrometers both inclusive, the mercury penetration amount being measured by a mercury injection method.

4. The secondary battery according to claim 1, the secondary battery is a lithium ion secondary battery.

5. An active material, the active material having a composition represented by Formula (1) described below, wherein
a median diameter (D90) of the active material is from about 10.5 micrometers to about 60 micrometers both inclusive, the median diameter (D90) being measured by a laser diffraction method, and
a half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method,
LiₐMn_{b}Fe_{c}M_{d}PO₄ (1)
where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

6. A method of manufacturing an active material, the method comprising:
compressing a powdery raw material to form a molded product; and
subsequently firing and pulverizing the molded product to form an active material having a composition represented by Formula (1) described below, wherein
density of the molded product in the compressing of the powdery raw material is from about 0.5 milligrams per cubic centimeter to about 2.3 milligrams per cubic centimeter both inclusive, and
a median diameter (D50) of the active material in the pulverizing of the molded product is from about 5 micrometers to about 30 micrometers both inclusive,
LiₐMn_{b}Fe_{c}M_{d}PO₄ (1)
where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

7. The method of manufacturing an active material according to claim 6, wherein
a thickness of the molded product in the compressing of the powdery raw material is substantially equal to or less than about 6 millimeters, and
firing temperature in the firing of the molded product is from about 400 degrees Celsius to about 800 degrees Celsius both inclusive.

8. An electrode including an active material, the active material having a composition represented by Formula (1) described below, wherein
a median diameter (D90) of the active material is from about 10.5 micrometers to about 60 micrometers both inclusive, the median diameter (D90) being measured by a laser diffraction method, and
a half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method,
LiₐMn_{b}Fe_{c}M_{d}PO₄ (1)
where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

9. A battery pack comprising:
a secondary battery, the second battery including a cathode including an active material, an anode, and an electrolytic solution;
a control section controlling a usage state of the secondary battery; and
a switch section switching the usage state of the secondary battery according to a direction of the control section, wherein
the active material has a composition represented by Formula (1) described below,
a median diameter (D90) of the active material is from about 10.5 micrometers to about 60 micrometers both inclusive, the median diameter (D90) being measured by a laser diffraction method, and
a half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method,
LiₐMn_{b}Fe_{c}M_{d}PO₄ (1)
where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

10. An electric vehicle comprising:
a secondary battery, the second battery including a cathode including an active material, an anode, and an electrolytic solution;
a conversion section converting electric power supplied from the secondary battery to drive power;
a drive section driving the electric vehicle according to the drive power; and
a control section controlling a usage state of the secondary battery, wherein
the active material has a composition represented by Formula (1) described below,
a median diameter (D90) of the active material is from about 10.5 micrometers to about 60 micrometers both inclusive, the median diameter (D90) being measured by a laser diffraction method, and
a half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method,
LiₐMn_{b}Fe_{c}M_{d}PO₄ (1)
where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

11. An electric power storage system comprising:
a secondary battery, the second battery including a cathode including an active material, an anode, and an electrolytic solution;
one, or two or more electric devices; and
a control section controlling electric power supply from the secondary battery to the one, or two or more electric devices, wherein
the active material has a composition represented by Formula (1) described below,
a median diameter (D90) of the active material is from about 10.5 micrometers to about 60 micrometers both inclusive, the median diameter (D90) being measured by a laser diffraction method, and
a half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method,
LiₐMn_{b}Fe_{c}M_{d}PO₄ (1)
where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

12. An electric power tool comprising:
a secondary battery, the second battery including a cathode including an active material, an anode, and an electrolytic solution; and
a movable section being supplied with electric power from the secondary battery, wherein
the active material has a composition represented by Formula (1) described below,
a median diameter (D90) of the active material is from about 10.5 micrometers to about 60 micrometers both inclusive, the median diameter (D90) being measured by a laser diffraction method, and
a half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method,
LiₐMn_{b}Fe_{c}M_{d}PO₄ (1)
where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.

13. An electronic device comprising:
a secondary battery, the second battery including a cathode including an active material, an anode, and an electrolytic solution, wherein
the electronic device is supplied with electric power from the secondary battery,
the active material has a composition represented by Formula (1) described below,
a median diameter (D90) of the active material is from about 10.5 micrometers to about 60 micrometers both inclusive, the median diameter (D90) being measured by a laser diffraction method, and
a half bandwidth (2θ) of a diffraction peak corresponding to a (020) crystal plane of the active material is from about 0.15 degrees to about 0.24 degrees both inclusive, the half bandwidth (2θ) being measured by an X-ray diffraction method,
LiₐMn_{b}Fe_{c}M_{d}PO₄ (1)
where M represents one or more of Mg, Ni, Co, Al, W, Nb, Ti, Si, Cr, Cu, and Zn; and 0<a≦2, 0<b<1, 0<c<1, 0≦d<1, and b+c+d=1 are established.
